(19) United States
(12) Patent Application Publication
(10) Pub. No.: US 2004/0093396 A1
(43) Pub. Date: May 13, 2004

(54) Data distribution method, server, and terminal

(76) Inventor: Makoto Akune, Tokyo (JP)

Correspondence Address: Jay H. Maioli, Cooper & Dunham LLP, 1185 Avenue of the Americas, New York, NY, 10036, US

(21) Appl. No.: 10/666,496

(22) Filed: Sep. 19, 2003

(30) Foreign Application Priority Data
Oct. 29, 2002 (JP) P2002-314083

(51) Int. Cl. G06F 15/16; G06F 17/00

(52) U.S. Cl. 709/219; 700/94; 705/51

(57) ABSTRACT

In a data distribution method, information for downloading content, transmitted from a user is classified. When the information for downloading content is classified as indicating downloading of new content data, one of a plurality of pieces of content data having predetermined formats is selected based on the information for downloading content, and the selected content data is sent to the user. When the information for downloading content is classified as indicating downloading of upgrading data associated with content data owned by the user, upgrading data is sent to the user.

### BACKGROUND OF THE INVENTION

1. Field of the Invention

The present invention relates to data distribution methods, servers, and terminals. More specifically, the present invention relates to a data distribution method, a server, and a terminal for distribution of content data.

2. Description of the Related Art

In systems for content distribution services, content data such as audio data of music or video data of a motion picture is distributed to a user via a network such as the Internet, and a price for the service is charged to and collected from the user.

In such as content distribution service, for example, a user accesses a server that distributes content, using a personal terminal capable of networking, such as a personal computer. The user downloads data including desired content from the server via a network, and stores the data on a storage medium such as a hard disk drive (HDD). The user is allowed to play back the content data stored and enjoy the content.

Audio data or video data can be classified on the basis of formats. A format herein refers to a sampling frequency and a sampling bit rate (quantization word length).

For example, in the case of audio data, a signal based on the well-known CD-DA (Compact Disc Digital Audio) standard has a format with a sampling frequency of 44.1 kHz and a sampling bit rate of 16 bits. Another existing format has a sampling frequency of 192 kHz and a sampling bit rate of 24 bits.

Furthermore, audio data in formats compressed based on particular audio compression methods exists. For example, ATRAC (Adaptive TRansform Acoustic Coding™) is a well-known audio compression method.

Difference among such formats causes difference in the accuracy of audio data to an acoustic source. For example, a signal waveform supplied from an acoustic source is maintained more accurately as the sampling frequency becomes higher and as the sampling bit rate becomes larger. Thus, if the same content in difference formats is played back under the same playback conditions, as the sampling frequency becomes higher and as the sampling bit rate becomes larger, the quality of sound that is played back becomes higher, that is, a playback output of a higher grade can be obtained.

Also, regarding formats of video data, as the sampling frequency becomes higher and as the sampling bit rate becomes larger, the quality of picture that is played back becomes higher, that is, the picture that is played back has an improved picture quality.

Now, let it be supposed that a user has downloaded certain content data using a personal terminal as described above, played back the content data to listen to the content, finding the content to be nice, and now wishes to play back the content in a higher quality.

However, under the current situation, if the user wishes to play back content data that has already been downloaded, but now in a higher quality, the user must newly download content data of the same content in a format of a higher quality. The user has to again pay a price for the content data newly downloaded.

Otherwise, instead of downloading, the user must newly purchase a package medium having recorded having recorded thereon the same content data in a format of a higher quality. Also in this case, the user has to pay a price for the content data of a higher quality, for the same content that has already been obtained.

As described above, if a user wishes to play back content data obtained before, but now in a higher quality, it has been the case that the user has to pay a price separately for the content data of the higher quality even though the user has already paid a price for purchasing the content. That is, the user only wishes to upgrade the content the user already owns and to thereby own a single upgraded piece of music. Unreasonably, however, the user ends up in paying prices for a plurality of pieces of music for the same content.

### SUMMARY OF THE INVENTION

In view of the situation described above, it is an object of the present invention to provide a data distribution method that solves the problem described above.

It is another object of the present invention to provide a server that solves the problem described above.

It is yet another object of the present invention to provide a terminal that solves the problem described above.

According to an aspect of the present invention, a data distribution method is provided. In the data distribution method, information for downloading content, transmitted from a user is classified. When the information for downloading content is classified as indicating downloading of new content data, one of a plurality of pieces of content data having predetermined formats is selected based on the information for downloading content, and the selected content data is sent to the user. When the information for downloading content is classified as indicating downloading of upgrading data associated with content data owned by the user, upgrading data is sent to the user.

According to another aspect of the present invention, a server including a storage unit, first and second generating units, a sending and receiving unit, and a controller is provided. The storage unit stores a plurality of pieces of content data having predetermined formats. The first generating unit generates content data to be distributed, based on data supplied thereto. The second generating unit generates upgrading data using content data read from the storage unit. The sending and receiving unit receives data output from the first generating unit or the second generating unit, and sends and receives data to and from outside via a network. The controller receives information for downloading content from the sending and receiving unit, and exercises control based on the information for downloading content. The controller classifies the information for downloading content. When the information for downloading content is classified as indicating downloading of new content data, the controller selects one of the plurality of pieces of content data having the predetermined formats, based on the information for downloading content, and supplies the selected content data to the first generating unit. When the information for downloading content is classified as indicating downloading of upgrading data associated with content data owned by the user, the controller causes the second generating unit to generate upgrading data.

According to yet another aspect of the present invention, a terminal including a sending and receiving unit, a storage unit, a signal processing unit, and a controller is provided. The sending and receiving unit sends and receives data to and from a server via a network. The storage unit stores content data and upgrading data received from the sending and receiving unit. The signal processing unit decodes content data read from the storage unit, in accordance with encoding of the content data, and generates content data having a quality higher than a quality of the content data read from the storage unit, based on the content data and upgrading data read from the storage unit. The controller exercises control as to whether the signal processing unit decodes the content data read from the storage unit or generates the content data having the higher quality.

### BRIEF DESCRIPTION OF THE DRAWINGS

FIG. 1 is a block diagram showing an example configuration of a content distribution system according to the present invention;

FIG. 2 is a block diagram showing an example configuration of a content server;

FIG. 3 is a block diagram showing an example configuration of a personal terminal;

FIG. 4 is a diagram showing a flow of operations of the personal terminal and the content server in the content distribution system;

FIG. 5 is a diagram showing an example data structure of base data;

FIG. 6 is a diagram showing an example structure of upgrading data;

FIG. 7 is a diagram showing information stored in a storage unit of the content server;

FIG. 8 is a diagram schematically showing a format conversion database stored in the storage unit of the content server;

FIG. 9 is a diagram showing association between formats of content data and format numbers;

FIG. 10 is a diagram showing upgrading types according to the present invention;

FIG. 11 is a diagram showing an example structure of usage-history information stored in the storage unit of the content server;

FIG. 12 is a diagram showing an example structure of a user database stored in the storage unit of the content server;

FIG. 13 is a diagram showing an example structure of charge information stored in the storage unit of the content server;

FIG. 14 is a block diagram showing an example configuration of a base-data generating unit of the content server;

FIG. 15 is a block diagram showing an example configuration of an upgrading-data generating unit of the content server;

FIG. 16 is an arrow chart showing processes executed by the personal terminal and the content server for content distribution according to the present invention;

FIG. 17 is an arrow chart showing processes executed by the personal terminal and the content server for content distribution according to the present invention;

FIG. 18 is a block diagram showing an example configuration of a content-data combining unit of the personal terminal;

FIG. 19 is a block diagram showing an example configuration of a content-data combining unit of the personal terminal; and

FIG. 20 is a diagram showing association between select signals generated by select-signal generating units of the content-data combining unit and content grades of input data.

### DESCRIPTION OF THE PREFERRED EMBODIMENTS

Now, preferred embodiments of the present invention will be described with reference to the accompanying drawings, in the following order:

1. Configuration of Content Distribution System

1-1. Overall Configuration

1-2. Content Server

1-3. Personal Terminal

2. Example Usage of Content Distribution System

3. Scheme for Content Distribution by Content Server

3-1. Structures of Content Data

3-2. Content-Related Information

3-3. User-Related Information

3-4. Charging-Related Information

3-5. Base-Data Generating Unit

3-6. Upgrading data Generating Unit

4. Processes Executed for Content Distribution

5. Signal Processing of Content Data at Personal Terminal

1. Configuration of Content Distribution System

1-1. Overall Configuration

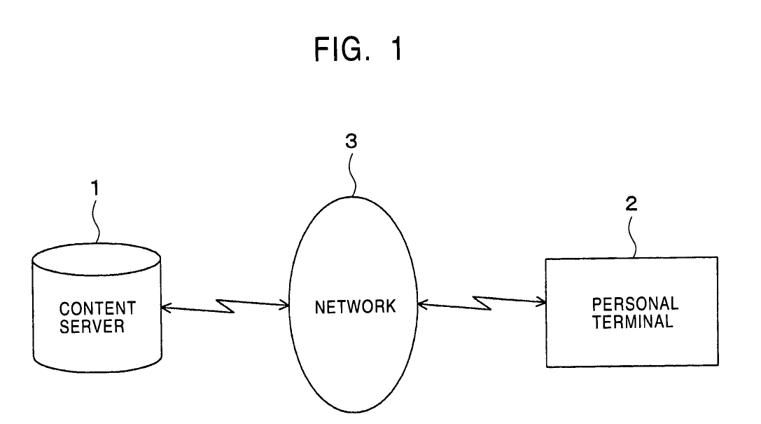

FIG. 1 shows the configuration of a content distribution system according to an embodiment of the present invention. As shown in FIG. 1, the content distribution system is formed by connecting a content server 1 and a personal terminal 2 with each other via a network 3.

The content server 1 shown in FIG. 1 is used to distribute audio data of music as content data. As will be described later in detail, the types of content data distributed by the content server 1 include base data and upgrading data. The content server 1 sends content data in response to a request from the personal terminal 2.

The personal terminal 2 is, for example, a terminal owned individually by a user of the content distribution system of this embodiment. For example, the personal terminal 2 is a personal computer or a personal digital assistant (PDA). Although only the single personal terminal 2 is shown in FIG. 1 for simplicity, actually, a plurality of personal terminals is connected to the server 1 via the network 3.

The personal terminal 2 is allowed to download content data stored in the server 1, i.e., to receive and locally store content data.

The personal terminal 2 is also allowed to play back the content data received as described above, thereby outputting a corresponding audio signal.

The network 3 is not limited to a particular type of network. Under the current situation, for example, a global network over the Internet can be used. Actually, however, the personal terminal 2 may be connected to the network 3 via, for example, a local area network (LAN).

1-2. Content Server

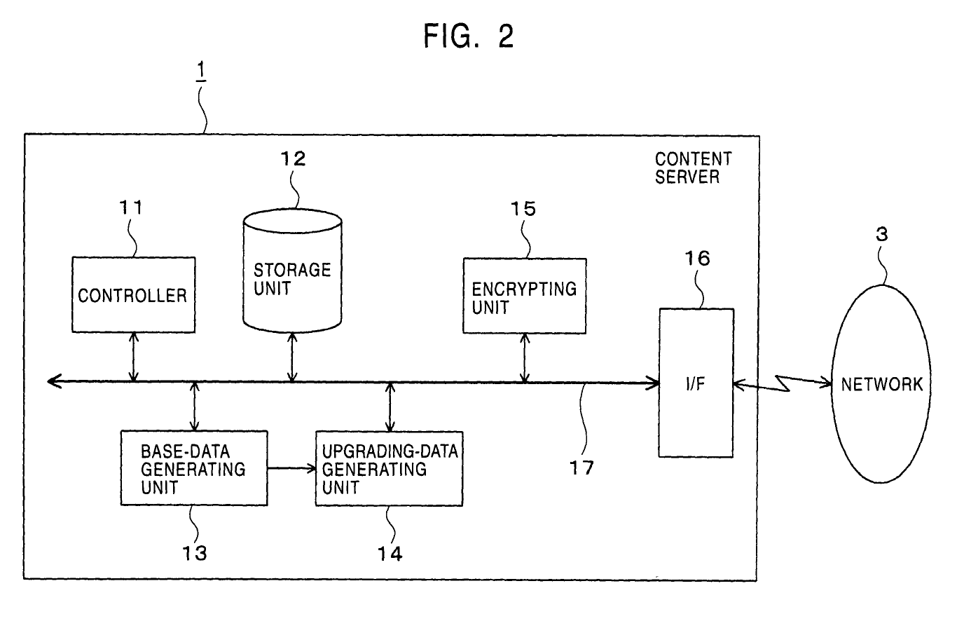

FIG. 2 shows an example internal configuration of the content server 1. As shown in FIG. 2, the content server 1 includes a controller 11, a storage unit 12, a base-data generating unit 13, an upgrading-data generating unit 14, an encrypting unit 15, and an interface 16. These components are connected to each other via a system bus 17.

The controller 11 is implemented, for example, by a microcomputer including a central processing unit (CPU), a random access memory (RAM), and a read-only memory (ROM). The controller 11 controls the overall operation of the content server 1.

The storage unit 12 is capable of storing a large volume of data. Under the current situation, the storage unit 12 is implemented, for example, by a hard disk drive (HDD). Data that is to be stored in the storage unit 12 includes, for example, content data to be distributed, various user-related information regarding users of the content distribution system, and charging-related information used for charging processes associated with content distribution. Specific examples of such data will be described later. The storage unit 12 also stores programs to be executed by the controller 11 (CPU).

Data is written to or read from the storage unit 12 by the controller 11, for example, based on a file system.

The types of content data distributed by the content server 1 include base data and upgrading data.

Base data refers to audio data in a predetermined format. The format herein refers to a data format that is determined by a sampling frequency and a sampling bit rate (quantization word length).

Audio data that serves as base data is complete by itself as a single piece of audio data. That is, base data refers to such data that can be independently decoded to output a corresponding audio signal normally.

On the other hand, upgrading data refers to difference data including information required for upgrading a format of base data to a target format, that is, difference data between an original format of base data and a target format.

The upgrading of format causes increase in at least one of the sampling frequency and the sampling bit rate of the data. The upgrading of format thus reduces the amount of information content that is lost from an original signal, so that a sound that is played back under a constant playback environment exhibits a higher quality. That is, the upgrading of format upgrades the quality of content data.

The base-data generating unit 13 is a functional unit that executes signal processing for generating base data.

In this embodiment, content data that is stored in the storage unit 12 is audio data having a quality higher than the quality of any format of base data that is to be distributed. Hereinafter, the content data stored in the storage unit 12, i.e., the audio data having the highest quality, will be referred to as original content data.

The base-data generating unit 13 executes signal processing on the audio data that serves as original content data, such as conversion of the sampling frequency and down-sampling (decimation), thereby generating audio data in a needed format, which serves as base data.

The upgrading-data generating unit 14 is a functional unit for generating upgrading data described earlier. The upgrading-data generating unit 14, for example, under the control of the controller 11, extracts difference between pieces of base data in a plurality of different formats, generated by the base-data generating unit 13, generating difference data needed for upgrading. The upgrading-data generating unit 14 outputs the difference data as upgrading data.

Specific configurations of the base-data generating unit 13 and the upgrading-data generating unit 14 will be described later.

The encrypting unit 15 encrypts content data (base data and upgrading data) that is sent from the content server 1. The method of encryption is not limited to a particular method. For example, under the current situation, content data is encrypted based on a public-key cryptosystem that is commonly used for data distribution and the like. For example, if data communication via the network 3 is takes place in the form of transmission of packets, content data may be divided into packets before being encrypted.

The interface 16 is provided to allow exchange of data via the network 3.

When data such as content data is sent from the content server 1, transmission data is supplied to the interface 16 via the system bus 17 under the control of the controller 11. The interface 16 encodes the transmission data into a data format suitable for data transmission via the network 3, for example, packetizes the transmission data. The interface 16 then sends the resulting data to a particular device connected to the network 3, such as the personal terminal 2.

The interface 16, upon receiving data transmitted via the network 3, decodes the data as needed, for example, unpacketizes the data. The interface 16 then outputs the decoded data to a relevant functional unit via the system bus 17 under the control of the controller 11.

1-3. Personal Terminal

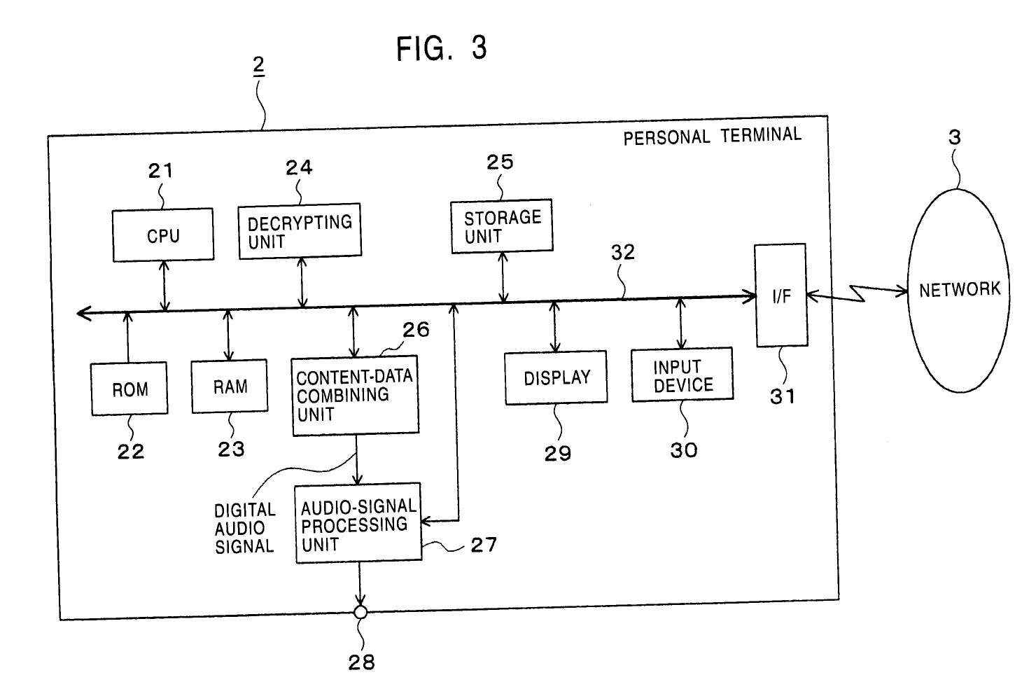

FIG. 3 shows an example internal configuration of the personal terminal 2.

As shown in FIG. 3, the personal terminal 2 includes a CPU 21, a ROM 22, a RAM 23, a decrypting unit 24, a storage unit 25, a content-data combining unit 26, an audio-signal processing unit 27, a display 29, an input device 30, and an interface 31. These components are connected to each other via a data bus 32.

The CPU 21 controls the overall operation of the personal terminal 2. Programs to be executed by the CPU 21 are stored, for example, in the ROM 22 or the storage unit 25.

The ROM 22, as described above, stores programs to be executed by the CPU 21. Furthermore, the ROM 22 may also store various setting information that is needed for processing by the CPU 21.

The RAM 23 is used as a work area when the CPU 21 executes processing based on programs.

As described with reference to FIG. 2, the content server 1 sends encrypted content data to the personal terminal 2. The decrypting unit 24 receives, via the data bus 32, input of content data received by the interface 31, which will be described later, under the control of the CPU 21. The decrypting unit 24 decrypts the encrypted content data input thereto. The decrypted content data is transferred to and written to the storage unit 25 under the control of the CPU 21.

Alternatively, the arrangement may be such that content data received is stored in the storage unit 25 without being decrypted, and that the decrypting unit 24 decrypts content data read from the storage unit 25 when decryption is needed, for example, at a time of playback.

As described earlier, the storage unit 25 mainly stores content data (base data and upgrading data). The storage unit 25 may store files other than content data, for example, in accordance with user's operations. Furthermore, the storage unit 25 may also store programs to be executed by the CPU 21, as described earlier.

The storage unit 25 is, for example, an HDD in the case of a personal computer. The storage unit 25 must be capable of storing at least downloaded content data. Thus, the storage unit 25 may be implemented, for example, by a removable media that allows-recording thereon and an associated media drive.

The content-data combining unit 26, for example, under the control of the CPU 21, receives input of base data and upgrading data for the same piece of content (represented by the same content ID). The content-data combining unit 26 combines the base data and the upgrading data input thereto, thereby generating content data (audio data) having a higher grade, i.e., a high quality, compared with the base data.

The audio data having been upgraded as described above is supplied to the audio-signal processing unit 27, where it is decoded based on the upgraded format and is thereby converted into audio data having a prescribed sampling frequency and sampling bit rate, which is output from an audio output terminal 28.

The audio data output from the audio output terminal 28 undergoes D/A conversion by an audio amplifier or the like and is thereby converted into an analog audio signal, which is supplied to a speaker or the like to output a sound.

Alternatively, the arrangement may be such that the audio-signal processing unit 27 is cable of D/A conversion, controlling the volume of output signal, controlling the sound quality, etc. so that an analog audio signal will be output from the audio output terminal 28. In that case, a speaker, a headphone, or the like is connected to the audio output terminal 28.

Furthermore, the personal terminal 2 may be provided with a speaker that is connected to the audio-signal processing unit 27 so that sound corresponding to content data that is played back will be output from the speaker.

The display 29 displays a prescribed image under the control of the CPU 21.

The input device 30 is, for example, an operating device that is provided in association with the personal terminal 2. Alternatively, if the personal terminal 2 is a personal computer or the like, the input device 30 may include devices for inputting various operational information, such as a keyboard, a mouse, and a trackpad.

Operational information in accordance with an operation performed using the input device 30 is input to the CPU 21 via the data bus 32. The CPU 21 controls the operation of the personal terminal 2 in accordance with the operational information input thereto.

The interface 31, under the control of the CPU 21, exchanges data via the network 3. The interface encodes or decodes data exchanged, similarly to the interface 16 described with reference to FIG. 2.

2. Example Usage of the Content Distribution System

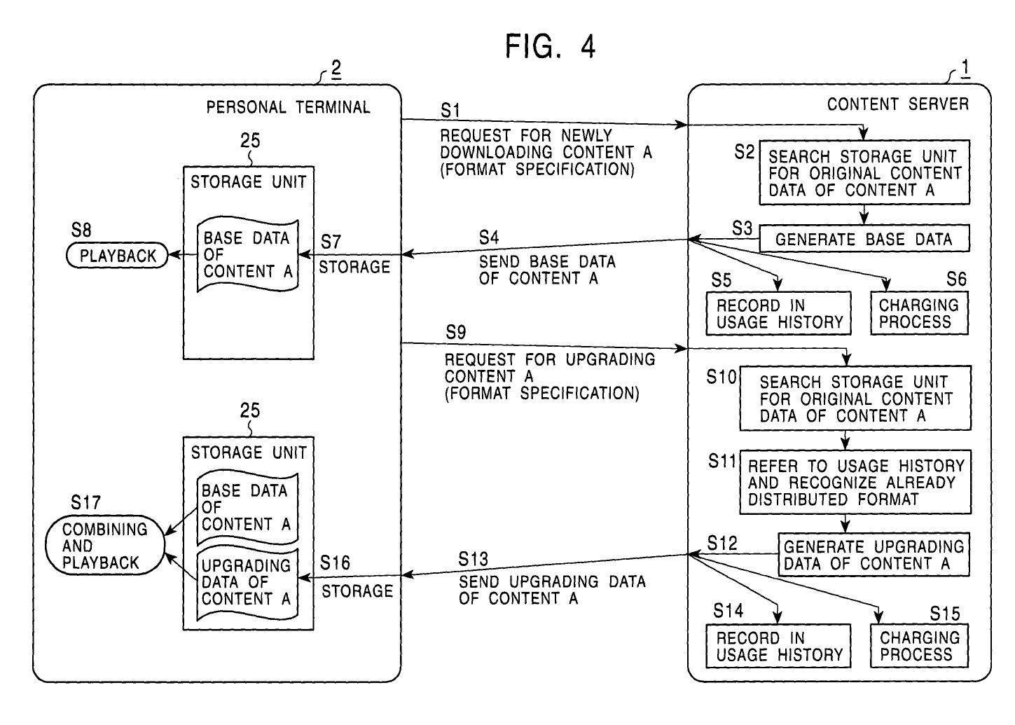

Referring next to FIG. 4, an example usage of the content distribution system of this embodiment will be described in relation to operations of the content server 1 and the personal terminal 2 in accordance with operations by the user.

The operation of the system will be described below only schematically, and will be described later in more detail in relation to the flow of processing operations executed by the content server 1 and the personal terminal 2 according to programs.

Descriptions with reference to FIG. 4 will be made in order of the numerals shown in FIG. 4, i.e., in order of steps S1 to S17 of the operation of the system.

### Step S1

First, the user connects the personal terminal 2 to the content server 1 via the network 3. The user then specifies content data to be downloaded and a format thereof by operating the input device 30 of the personal terminal 2, and sends data of a download request. For example, the user performs an input operation on a user-interface screen displayed on the display 29, using the input device 30.

In accordance with the input operation, the personal terminal 2 sends, to the content server 1, data of a request for downloading content data.

Let it be supposed herein that, in step S1, the user performs an operation for downloading new content data, i.e., downloading data of content (music) that has not been downloaded yet. Also, let it be supposed herein that content A has been selected as content to be downloaded. The content A is actually identified by identifying a content ID, which is uniquely assigned to each piece of content data.

### Step S2

The data of the download request, sent in step S1, is received by the content server 1. Steps S2 to S4 are executed by the content server 1 in response to the data of the download request. In this example, the download request specifies downloading of new content. In response to the request for downloading new content, the content server 1 sends base data of the specified content to the personal terminal 2.

For this purpose, in step S2, the content server 1 searches for and reads original content data of content A, specified by the download request, from the storage unit 12.

### Step S3

The original content data of the content A, read from the storage unit 12 in step S2, is input to the base-data generating unit 13. The base-data generating unit 13 generates audio data that is encoded in a format specified by the download request. The encoded audio data serves as base data of the content A.

### Step S4

The base data of the content A, generated as described above, is sent to the personal terminal 2 that has issued the download request.

### Step S5

When the base data of the content A is sent as described above, information for addition or updating is written to usage-history information stored in the storage unit 12. The usage-history information is a piece of information associated with the user. The usage-history information includes information indicating that the content distributed to the user is new content (base data), information indicating that the content data is data of the content A, and information indicating a format of the base data.

### Step S6

When the base data of the content A has been sent as described above, the content server 1 executes a charging process as required so that a price that is prescribed for distribution of the base data of the content A will be paid by the user.

### Step S7

The personal terminal 2, upon receiving the base data of the content A, sent in step 4, stores the base data in the storage unit 25.

### Step S8

As described earlier, the base data of the content A can be independently processed for playback to output a corresponding sound. Thus, the base data of the content A, temporarily stored in the storage unit 25, can be played back at an arbitrary timing by the user operating the input device 30 for playback.

### Step S9

Let it be supposed that at a timing after the base data of the content A has been downloaded as described above, the user now wishes to listen to the content A in a higher quality. The content-data distribution system of this embodiment, in response to such a request, also provides a service of distributing upgrading data to the user, the upgrading data allowing upgrading of the quality of the content already downloaded by the user. Step S9 and subsequent steps relate to distribution of such upgrading data.

In step S9, the user specifies the content A as content to be downloaded and also specifies a format to be obtained by upgrading, by a predetermined operation similar to the operation in step 1, and sends data of an upgrading request. Obviously, the format specified for upgrading has a higher quality than the format of the base data of the content A that has already been downloaded.

### Step S10

The content server 1 receives the data of the upgrading request, sent in step S9 as described above. The content server 1 searches for and reads the original content data of the content A, specified by the current upgrading request, from the storage unit 12. The original content data retrieved by the search is used to generate upgrading data (difference data).

### Step S11

Then, the content server 1 refers to the usage-history information of the user that has issued the current upgrading request to determine the format of the content data of the content A that has already been distributed to the user.

### Step S12

Let the format for upgrading specified by the upgrading request sent in step 9 will be denoted as a and the format of the content A that has already been distributed and determined in step S11 (base data in this example) as b. Schematically, data representing the difference between the format of the base data of the content A that has already been distributed and the format for upgrading currently requested can be obtained by calculating (a−b).

In step S12, as upgrading data for the content A, difference data corresponding to the difference (a−b) between the formats is generated. In generating the difference data, the base-data generating unit 13 first generates pieces of audio data corresponding to the formats a and b, respectively, and the upgrading-data generating unit 14 then generates difference data using these pieces of audio data. This will be described later in more detail.

### Step S13

The difference data that serves as upgrading data, generated as described above, is sent to the personal terminal 2.

### Step S14

When the upgrading data for the content A is sent as described above, information for addition or upgrading is recorded in the usage-history information stored in the storage unit 12. Thus, the usage-history information includes information indicating that, with regard to the content A, the base data having the format a and the upgrading data for upgrading to the format b have been distributed to the user.

### Step S15

When the upgrading data is sent to the user, the content server 1 executes a charging process as needed so that a price prescribed for the updating data will be paid by the user. For example, the price the user is charged with at this time is prescribed to be less expensive than the price for downloading the base data.

### Step S16

The personal terminal 2 receives the upgrading data of the content A, sent as described above, and stores the upgrading data in the storage unit 25.

### Step S17

When the upgrading data of the content A has been stored in the storage unit 25 as described above, the storage unit 25 now stores the base data and the upgrading data of the content A. Thereafter, audio data can be played back by reading the base data and the upgrading data from the storage unit 25 and combining the base data and the upgrading data in the content-data combining unit 26. The audio data obtained by combining the base data and the upgrading data has the upgraded format b specified by the user. That is, the user is allowed to listen to a sound of a higher quality compared with a case where the base data is played back independently.

As described above, according to the content distribution system of this embodiment, when content data is newly downloaded, audio data that can be played back independently, i.e., base data, is downloaded as content data.

After that, when the user wishes to play back the content, of which the base data has been download, this time in a format having a higher quality, according to the present invention, upgrading data that allows the base data to be converted into a format having a higher quality specified by the user can be downloaded. The personal terminal 2 is allowed to combine the base data and the upgrading data that have been downloaded so that the content can be played back in a higher quality compared with a case where the base data is played back independently.

Accordingly, the user of the personal terminal 2 already has base data of content in a certain format and wishes to play back the content in a higher quality, it suffices for the user to download upgrading data representing the difference from the content server 1. That is, the user does not have to newly purchase audio data in a high-quality format (that allows independent playback) for the purpose of playing back already owned content in a higher quality.

In managing the content distribution system of this embodiment, for example, a price for downloading upgrading data is prescribed to be less expensive than a price for purchasing audio data in a high-quality format so that the price is appropriate for the difference between the formats. Thus, the user only has to pay for a price for the difference between the formats (qualities). Accordingly, the economic burden on the user is reduced compared with a case where content data of a higher quality is newly purchased, and the pricing system is more reasonable for the user.

Furthermore, in this embodiment, as will be understood from the description with reference to FIG. 4, base data and upgrading data of a single piece of content is generated from original content data of the piece of content.

Thus, the content server 1 only has to store content data in a single format, i.e., original content data, in the storage unit 25, and does not have to store base data and upgrading data. Thus, the storage capacity of the storage unit 25 can be saved. Management of content data stored in the storage unit 25 becomes less complex, so that the processing load for management, searching, and writing and reading of data relating to the storage unit 25 is reduced accordingly.

As described with reference to FIG. 4, the user is allowed to select a format of base data and a format of upgrading data to be downloaded within a predetermined range of selection by operating the personal terminal 2. More specifically, a plurality of formats exists for base data of a single piece of content, and a considerable number of patterns of difference that is to be covered by upgrading data exists in accordance with the number of formats of base data and the number of formats for upgrading that can be selected by the user. Furthermore, the content server 1 stores a considerable number of pieces of content to be distributed.

Considering all this, the effect of saving the storage capacity of the storage unit 25 and reducing the processing load for managing data stored in the storage unit 25, achieved by storing only original content data as described above, is significant.

3. Scheme for Content Distribution by Content Server

3-1. Structures of Content Data

Next, the technical scheme for allowing distribution of content data by the content server 1 in response to a request from the personal terminal 2 will be described.

First various data and information needed in relation to distribution of content data will be described.

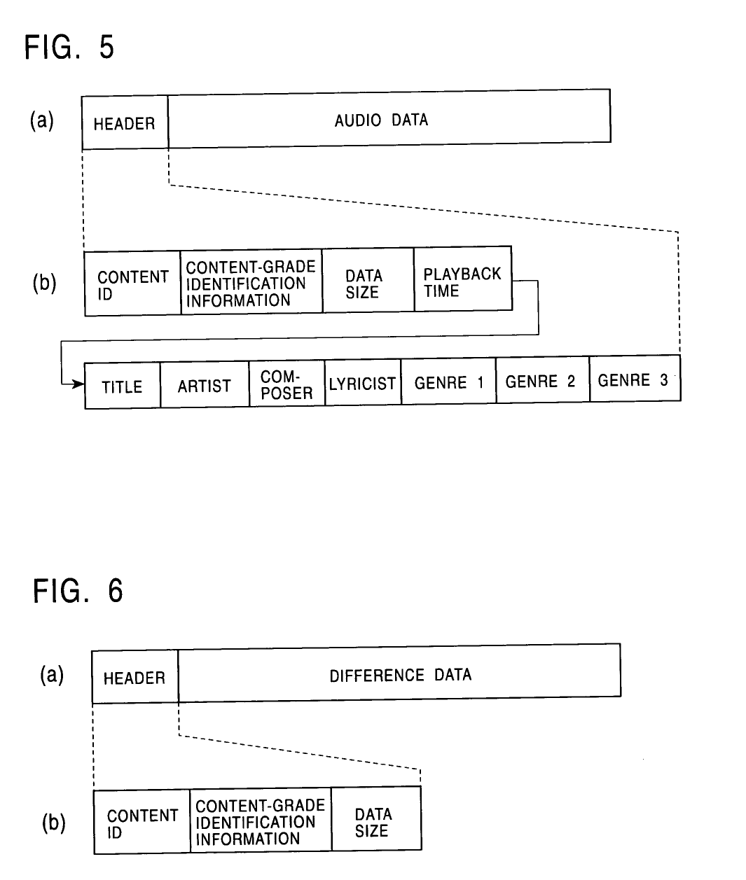

FIG. 5 shows the data structure of base data, which is a type of content data that is distributed in this embodiment. Referring to part (a) of FIG. 5, the base data includes a header, and audio data following the header. As will be understood from the above description, the audio data herein refers to audio data having been converted into a certain format.

The header includes various information items needed in relation to the base data, each of the information items having a predetermined data size. For example, as shown in part (b) of FIG. 5, the header includes a content ID at the beginning thereof. The content ID is information for identifying a piece of content, uniquely assigned to each piece of content by the content server 1. Base data and upgrading data of the same piece of content share the same content ID.

The content ID is followed by content-grade identification information. The content-grade identification information is information that allows identification of a format of the base data.

The content-grade identification information is followed by a data size, which represents a data size of the base data.

Furthermore, the data size is followed by various information items regarding the content of the base data. In the example shown, a playback time, a title, an artist (musician), a composer, a lyricist, a genre 1, a genre 2, and a genre 3 are included. Three fields for genre information are provided since it is possible that some musical piece is included in a plurality of genres. For example, the information items following the data size can be displayed as information relating to the content when a content-playback list is displayed on the display 29 or when the playback list is sorted.

The header information is not limited to that shown in part (b) of FIG. 5, and may be changed as needed.

FIG. 6 shows the structure of upgrading data.

As shown in part (a) of FIG. 6, the upgrading data includes a header, and difference data following the header.

The header includes, for example, as shown in part (b) of FIG. 6, a content ID, content-grade identification information, and a data size.

In the example shown in part (b) of FIG. 6, the playback time, the title, the artist (musician), the composer, the lyricist, and the genres 1 to 3, included in the header shown in part (b) of FIG. 5, are omitted. These information items such as the playback time are associated with the relevant piece of content, so that these information items sufficiently function by attaching these information items to base data that is to be played back independently to output a sound. Thus, these information items such as the playback time need not be attached to upgrading data.

The content ID of the upgrading data is the same value as the value of the content ID of the base data for the same piece of content.

The content-grade identification information of the upgrading data is identification information indicating an upgrading type. The upgrading type refers to a target format to which a base format is to be upgraded with the upgrading data.

3-2. Content-Related Information

Next, data that is stored and managed in the storage unit 12 of the content server 1 will be described.

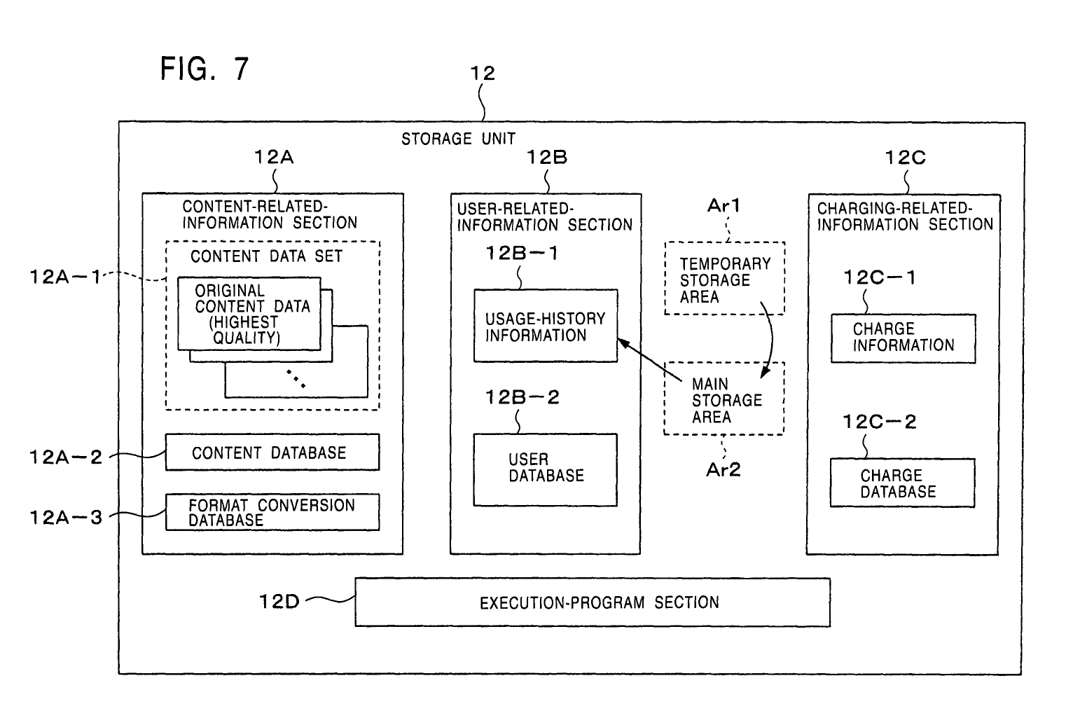

As shown in FIG. 7, the storage unit 12 generally includes a content-related-information section 12A, a user-related-information section 12B, a charging-related-information section 12C, and an execution-program section 12D.

The description will be made of the content-related-information section 12A, the user-related-information section 12B, and the charging-related-information section 12C, in that order.

The execution-program section 12D stores programs to be executed by the CPU of the controller 11 so that various operations of the content server 1 can be executed and controlled.

The content-related-information section 12A stores information relating to content to be distributed. For example, as shown in FIG. 7, the content-related-information section 12A includes a content-data set 12A-1, a content database 12A-2, and a format conversion database 12A-3.

The content-data set 12A-1 is a set of data that constitutes a group of original content data of content to be distributed by the content server 1. As described earlier, original content data refers to, for example, audio data of an entire piece of music in a predetermined format of a quality higher than the quality of any format of base data. That is, original content data allows audio data to be played back in a higher quality compared with any base data.

In this embodiment, original content data is, for example, one-bit digital audio signal obtained by ΔΣ modulation, i.e., a DSD (Direct Stream Digital) signal. The sampling frequency of the DSD signal is, for example, 2.8224 MHz, i.e., 64 times the sampling frequency fs (fs=44.1 kHz) of digital audio signals based on the CD-DA standard. The DSD signal is a digital audio signal that is ΔΣ modulated and quantized with one bit. The frequency band is so wide as to range from DC to 100 kHz, allowing playback of signals even beyond the audible frequency band. DSD signals allow a dynamic range of 120 dB over the entire audio band to be achieved. As will be understood from the above description, the DSD signal has a much higher quality compared with, for example, a digital audio signal based on the CD-DA standard.

The content database 12A-2 is a database that is provided in relation to the original content data constituting the content-data set 12A-1. The content database 12A-2 stores, for example, for each piece of original content data, predetermined information items such as a content ID and a recording position in the storage unit 25. Searching of original content data is done by referring to the content database 12A-2.

The format conversion database 12A-3 includes a table defining association between base formats and formats to which upgrading is possible using difference data.

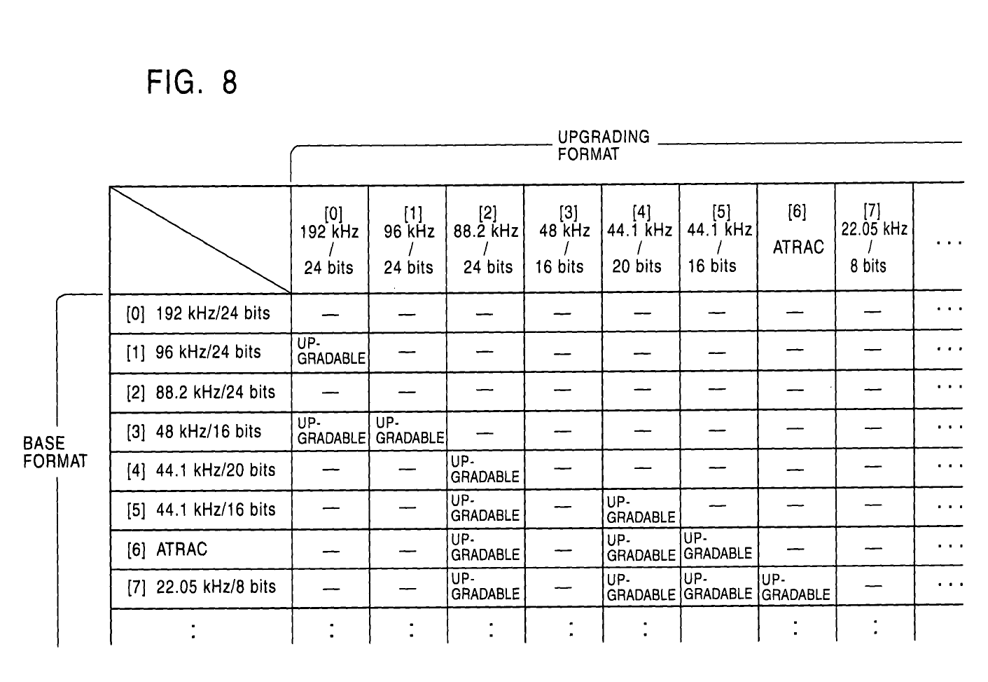

The format conversion database 12A-3 is schematically shown in FIG. 8.

FIG. 8 shows specific examples of content-data format in this embodiment.

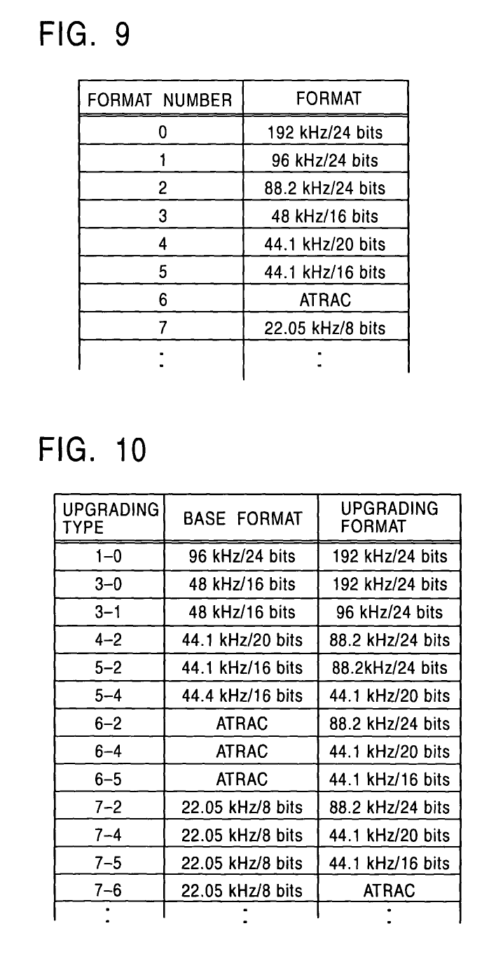

As shown in FIG. 9, formats of content data are managed based on format numbers.

For example, format number 0 represents a format of 192 kHz/24 bits. The notation “192 kHz/24 bits” indicates that the sampling frequency is 192 kHz and the sampling bit rate (quantization word length) is 24 bits.

The association between format numbers 1 to 7 and formats, shown in FIG. 9, is as follows:

| | |
|---|---|
| Format number 1: | 96 kHz/24 bits |
| Format number 2: | 88.2 kHz/24 bits |
| Format number 3: | 48 kHz/16 bits |
| Format number 4: | 44.1 kHz/20 bits |
| Format number 5: | 44.1 kHz/16 bits |
| Format number 6: | ATRAC |
| Format number 7: | 22.05 kHz/8 bits |

The format numbers are assigned to formats so that the qualities of the formats become lower in increasing order of their associated format numbers. That is, regarding format numbers 0 to 7, the format with format number 0 [192 kHz/24 bits] has a highest quality, and the format with format number 7 [22.05 kHz/8 bits] has a lowest quality.

ATRAC (Adaptive TRansform Acoustic Coding™), associated with format number 6, is a method of compressing audio data. ATRAC is herein used as a name of a format.

Referring back to FIG. 8, the format conversion database 12A-3 shown in FIG. 8 includes a matrix table in which base formats are arranged vertically in order of their format numbers and upgrading formats are arranged horizontally in order of their format numbers.

In the matrix table, each combination of a base format and an upgrading format that is indicated as “upgradable” has an upgradable relationship. On the other hand, each combination of a base format and an upgrading format that is indicated by “-” has an unupgradable relationship.

Referring to FIG. 8, for example, with regard to the base format with format number 1 [96 kHz/24 bits], upgrading is only possible to the format with format number 0 [192 kHz/24 bits].

With regard to the base format with format number 6 [ATRAC], upgrading is possible to three formats, namely, the format with format number 2 [88.2 kHz/24 bits], the format with format number 4 [44.1 kHz/20 bits], and the format with format number 5 [44.1 kHz/16 bits].

With regard to the upgradable combinations of base format and upgrading format, shown in FIG. 9, upgrading types are defined as shown in FIG. 10. As described earlier with reference to part (b) of FIG. 6, upgrading types are also used as content-grade identification information in headers of upgrading data.

For example, FIG. 10 shows that an upgrading type [1-0] corresponds to the combination of the base format with format number 1 [96 kHz/24 bits] and the upgrading format with format number 0 [192 kHz/24 bits].

That is, the notation of an upgrading type herein is [m-n], where m is the format number of a base format and n is the format number of an upgrading format.

The eight formats with format numbers 0 to 7, shown in FIG. 9, are only examples, and formats of base data that can be distributed by the content server 1 may be modified as appropriate. Furthermore, in addition to the eight formats with format numbers 0 to 7, base data in other formats may be generated for distribution.

Furthermore, upgrading types shown in FIG. 10 may be modified accordingly. That is, the number of upgrading types is increased as the number of formats of base data is increased.

3-3. User-Related Information

Next, the user-related-information section 12B of the storage unit 12 will be described.

The user-related-information section 12B stores information relating to users of the content distribution system of this embodiment. As shown in FIG. 7, the user-related-information section 12B includes a usage-history-information section 12B-1 and a user database 12B-2.

In the storage unit 12, a temporary storage area Ar1 and a main storage area Ar2 are allocated for storage by the usage-history-information section 12B-1, as shown in FIG. 7.

As will be described later, when processing for content distribution is being executed in response to a download request from the personal terminal 2, temporary usage-history information regarding the current download request is created, which is written to and temporarily stored in the temporary storage area Ar1.

When the processing for content distribution is completed, usage-history information that is to be actually registered, created based on the temporary usage-history information stored in the temporary storage area Ar1, is written in the main storage area Ar2. Thus, the main storage area Ar2 stores usage-history information of each user who has used content distribution system before.

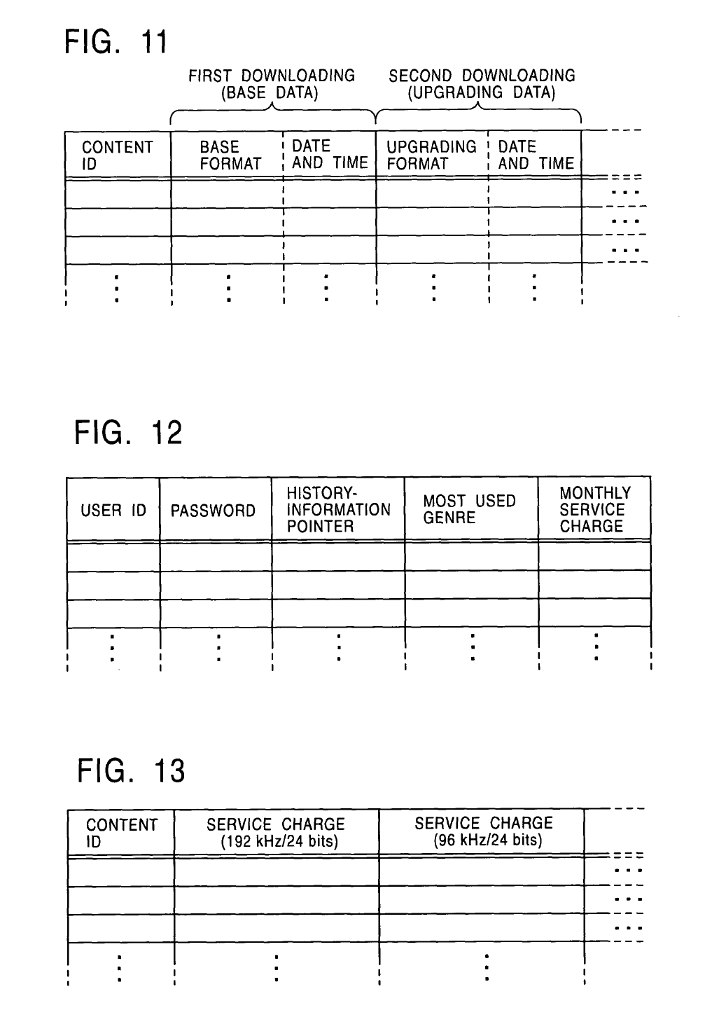

For example, usage-history information for each user, stored in the main storage area Ar2, has a structure shown in FIG. 11.

As shown in FIG. 11, usage-history information includes a list of content IDs representing pieces of content data that have been downloaded by the user. For each of the content IDs, information representing one base format and one or more upgrading formats is stored in association therewith.

The base format in the usage-history information indicates the format of base data downloaded first at the time of new downloading. The base format is represented by a format number described with reference to FIG. 9.

The information representing an upgrading format indicates a format of upgrading data downloaded by the second or later downloading operation relevant to the content. For example, the information representing the upgrading format includes a value indicating an upgrading type shown in FIG. 10.

For example, the user database 12B-2, which also belongs to the user-related-information section 12B, has a structure shown in FIG. 12.

As shown in FIG. 12, for each user ID, information such as a password, a history-information pointer, a most used genre, and a monthly charge is associated therewith in the user database 12B-2.

The user ID is identification information that is uniquely assigned to each user by the content server 1, so that a user can be identified by the user ID.

The password is, for example, arbitrarily set by the user and transmitted from the personal terminal 2. The password is used, for example, for user authentication.

The history-information pointer is a pointer indicating a storage position where usage-history information of a user identified by the user ID is stored among usage-history information stored in the main storage area Ar2. That is, when usage-history information of a user needs to be referred to, the user database 12B-2 is first referred to, to recognize a history-information pointer associated with the user ID of the user. Then, a position of the main storage area Ar2, indicated by the history-information pointer, is accessed to read usage-history information.

The most used genre indicates a genre of content that has been used most frequently according to downloading history of the user associated with the user ID.

The monthly charge indicates a price to be paid for content data downloaded by the user associated with the user ID, and the charge is managed on a monthly basis. The charge is managed on a monthly basis herein since an actual charging process is executed on a monthly basis.

3-4. Charging-Related Information

Next, the charging-related-information section 12C of the storage unit 12 will be described.

The charging-related-information section 12C stores information needed for executing a charging process associated with distribution of content data. The charging-related-information section 12C includes a charge-information section 12C-1 and a charge database 12C-2.

The charge-information section 12C-1, for example, as shown in FIG. 13, stores information of a price for each format in association with a content ID. In this embodiment, for example, at least, information of a price for each format of base data, shown in FIG. 9, is stored in association with each piece of content.

Information of a price for upgrading data can be obtained as described below.

For example, a price for upgrading data for each upgrading type, as well as a price for base data, is stored in the charge-information section 12C-1 in association with each content ID. In this case, a price for upgrading data for each upgrading type can be known by referring to the information stored in the charge-information section 12C-1.

As another example, the charge-information section 12C-1 stores only a price for each format of base data without storing a price for upgrading data.

Furthermore, when information of a price for upgrading data is needed, a price for a format of base data that has already been distributed and a price for an upgraded format are obtained from the charge-information section 12C-1. A price for upgrading data is calculated according to a predetermined rule based on the information of these prices.

The charge database 12C-2 is provided in association with the charge-information section 12C-1. For example, if certain information must be obtained from the charge-information section 12C-1, the charge database 12C-2 is used.

3-5. Base-Data Generating Unit

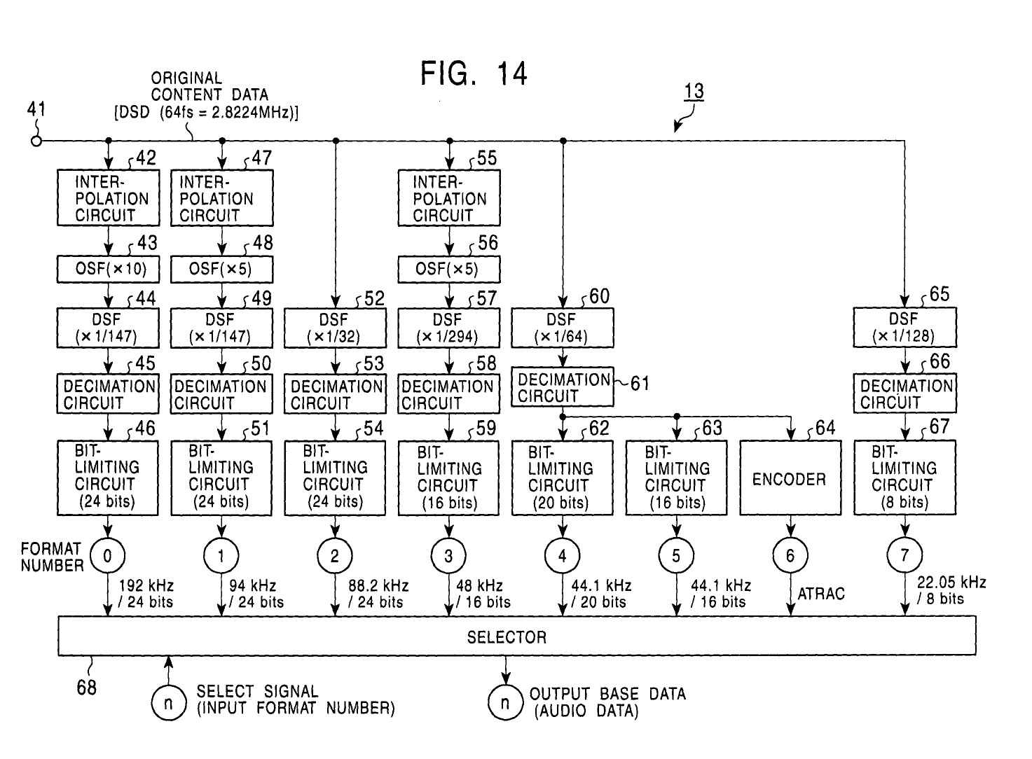

Next, an example circuit configuration of the base-data generating unit 13, which is provided for generating base data in the content server 1, will be described with reference to FIG. 14. In FIG. 14, for simplicity, base data generated by the base-data generating unit 13 is limited to eight formats with format numbers 0 to 7.

Referring to FIG. 14, in the base-data generating unit 13, audio data that serve as original content data, from which base data is to be generated, is supplied to an input terminal 41. As described earlier, the audio data that serves as original content data is what is called a DSD (Direct Stream Digital) signal. The DSD signal is a ΔΣ modulated, one-bit digital audio signal having a sampling frequency of 64 fs=2.8224 MHz, where fs=44.1 kHz, i.e., the sampling frequency of digital audio signal based on the CD-DA standard.

The DSD signal input to the input terminal 41 is branched and input to predetermined circuit blocks, as shown in FIG. 14.

One of the branched DSD signals is input to an interpolation circuit 42. The interpolation circuit 42 executes interpolation as a pre-process of oversampling, and outputs the result to an oversampling filter (OSF) 43.

The oversampling filter 43 executes oversampling by 10 on the signal input from the interpolation circuit 42, and outputs the result to a downsampling filter (DSF) 44.

The downsampling filter 44 executes downsampling by 1/147 on the signal input from the oversampling filter 43, and outputs the result to a decimation circuit 45. The decimation circuit 45 executes decimation on the signal input from the downsampling filter 44, as a post-process of downsampling, and outputs the result to a bit-limiting (word-length limiting) circuit 46.

The bit-limiting circuit 46 limits the sampling bit rate of the signal obtained by the processes described above to 24 bits.

Data output from the bit-limiting circuit 46 is audio data in the format [192 kHz/24 bits] with format number 0. That is, the signal processing line including the interpolation circuit 42 to the bit-limiting circuit 46 converts the DSD signal into the audio data of 192 kHz/24 bits.

Similarly, a DSD signal input to a signal processing line including an interpolation circuit 47, an oversampling filter 48 (×5), a downsampling filter 49 (×1/147), a decimation circuit 50, and a bit-limiting circuit 51 (24 bits) is converted into audio data with format number 1 [94 kHz/24 bits].

A DSD signal input to a signal processing line including a downsampling filter 52 (×1/32), a decimation circuit 53, and a bit-limiting circuit 54 (24 bits) is converted into audio data with format number 2 [88.2 kHz/24 bits].

A DSD signal input to a signal processing line including an interpolation circuit 55, an oversampling filter 56 (×5), a downsampling filter 57 (×1/294), a decimation circuit 58, and a bit-limiting circuit 59 (16 bits) is converted into audio data with format number 3 [48 kHz/16 bits].

A DSD signal that has been downsampled by the line including a downsampling filter 60 (×1/64) and a decimation circuit 61 is branched and input to a bit-limiting circuit 62 (20 bits), a bit-limiting circuit (16 bits) 63, and a compression encoder 64.

Data output from the bit-limiting circuit 62 (20 bits) is audio data with format number 4 [44.1 kHz/20 bits].

Data output from the bit-limiting circuit 63 (16 bits) is audio data with format number 5 [44.1 kHz/16 bits].

The compression encoder 64 compresses the signal (audio data) input from the decimation circuit 61, based on ATRAC. Thus, data output from the compression encoder 64 is audio data with format number 6 [ATRAC], i.e., audio data compressed based on ATRAC.

A DSD signal input to a signal processing line including a downsampling filter 65 (×1/128), a decimation circuit 66, and a bit-limiting circuit 67 (8 bits) is converted into audio data with format number 7 [22.05 kHz/8 bits].

The pieces of audio data with format numbers 0 to 7, generated by the signal processing lines as described above, are input to a selector 68.

The selector 68 receives input of a select signal indicating a format number n (n is an integer from 0 to 7 herein). The selector 68 selectively outputs audio data with the format number indicated by the select signal from among the pieces of audio data with format numbers 0 to 7. For example, if the select signal input indicates a format number n=5, the selector 68 outputs the audio data with format number 5 [44.1 kHz/16 bits], input from the bit-limiting circuit 63 (16 bits).

The audio data output from the selector 68 as described above serves as base data.

To the audio data output from the selector 68, a header as shown in part (b) of FIG. 5 is attached under the control of the controller 11, whereby the structure of base data shown in parts (a) and (b) of FIG. 5 is formed. The base data is supplied from the base-data generating unit 13 to the encrypting unit 15 via the system bus 17, where the base data is encrypted. The encrypted base data is sent from the interface 16 via the network 3 to the particular personal terminal 2 that has issued the relevant request for content.

When upgrading data is sent as content data, first, two pieces of base data in particular formats, needed to generate upgrading data, is generated, and the two pieces of base data are output to the upgrading-data generating unit 14.

3-6. Upgrading-Data Generating Unit

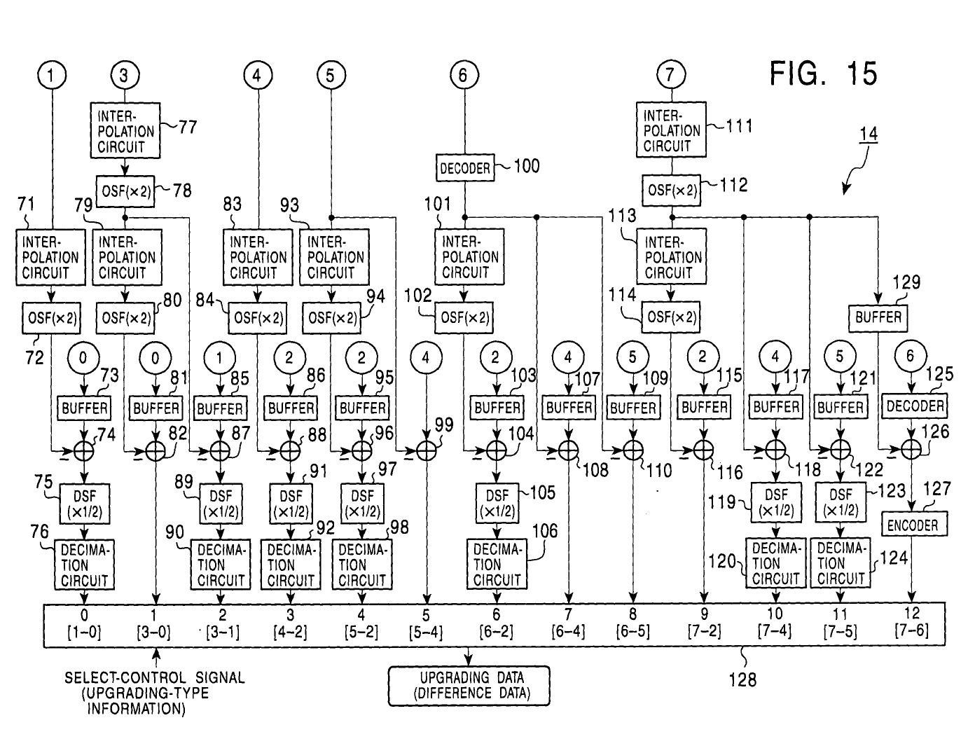

Next, the circuit configuration of the upgrading-data generating unit 14 will be described with reference to FIG. 15. In FIG. 15, the numerals 0 to 7 enclosed in circles represent the format numbers of audio data input to the upgrading-data generating unit 14. The input audio data are base data generated as described above by the base-data generating unit 13 from DSD signals.

Upgrading data that is to be generated in association with the seven pieces of base data with format numbers 0 to 7 are thirteen types of data of the upgrading types [1-0] to [7-6], as shown in FIG. 10. The upgrading-data generating unit 14 shown in FIG. 15 generates upgrading data of the thirteen upgrading types.

Upgrading data of the upgrading type [1-0] is generated in the following manner. As shown in FIG. 10, the upgrading data of the upgrading type [1-0] is difference data between audio data with format number 1 [96 kHz/24 bits] and audio data with format number 0 [192 kHz/24 bits].

Thus, when generating upgrading data of the upgrading type [1-0], first, the base-data generating unit 13 generates audio data with format number 1 [96 kHz/24 bits] and audio data with format number 0 [192 kHz/24 bits], and these pieces of audio data are used to generate the upgrading data.

Referring to FIG. 15, the audio data with format number 1 [96 kHz/24 bits] is input to an oversampling filter 72 (×2) via an interpolation circuit, where the audio data is oversampled by 2. Thus, the sampling frequency of the signal output from the oversampling filter 72 is 192 kHz, which is equivalent to the sampling frequency of audio data with format number 0. The signal output from the oversampling filter 72 is input to a subtractor 74.

The audio data with format number 0 [192 kHz/24 bits] is first temporarily stored in a buffer 73, and is then input to the subtractor 74. The buffer 73 is provided to absorb a time difference between two signals used for subtraction by the subtractor 74 and to thereby synchronize input timings of the two signals. Buffers 81, 85, 86, 95, 103, 107, 109, 115, 117, 121, and 129 are provided for similar purposes.

The subtractor 74 subtracts the signal input from the oversampling filter 72 (audio data with format number 1) from the signal input from the buffer 73 (audio data with format number 0). Thus, substantially, difference data of the data with format number 0 relative to the data with format number 1 is obtained.

The data output from the subtractor 74 is supplied to a decimation circuit 76 via a downsampling filter 75 (×1/2) where the data is downsampled by 1/2. Data obtained by the downsampling is difference data of the data with format number 0 relative to the data with format number 1, i.e., upgrading data of the upgrading type [1-0]. The upgrading data of the upgrading type [1-0] is input to an input terminal 0 of a selector 128.

Upgrading data of the upgrading type [3-0] is difference data between audio data with format number 3 [48 kHz/16 bits] and audio data with format number 0 [192 kHz/24 bits]. The upgrading data of the upgrading type [3-0] is generated based on these pieces of data in the following manner.

First, audio data with format number 3 [48 kHz/16 bits] is oversampled by 2 in two steps by a signal processing line including an interpolation circuit 77, an oversampling filter 78 (×2), an interpolation circuit 79 (×2), and an oversampling filter 80 (×2). The audio data is thus converted into a signal having a sampling frequency equivalent to that of a signal with format number 0 [192 kHz/24 bits], and the signal is input to a subtractor 82.

Audio data with format number 0 [192 kHz/24 bits] is temporarily stored in a buffer 81, and is then input to the subtractor 82.

The subtractor 82 subtracts the signal input from the oversampling filter 80 (format number 3) from the signal input from the buffer 81 (format number 0). Thus, upgrading data (difference data) of the upgrading type [3-0] is obtained. This upgrading data is input to an input terminal 1 of the selector 128.

Upgrading data of the upgrading type [3-1] is generated in the following manner.

Audio data with format number 3 [48 kHz/16 bits] is supplied to the oversampling filter 78 (×2) via the interpolation circuit 77, where the audio data is oversampled by 2. The audio data is thus converted into a signal having a sampling frequency equivalent to that of a signal with format number 1 [96 kHz/24 bits], and the signal is input to a subtractor 87.

Audio data with format number 1 [96 kHz/24 bits] is input from a buffer 85 to the subtractor 87. The subtractor 87 performs a subtraction to obtain difference data of data with format number 1 relative to the data with format number 3. The data output from the subtractor 87 is supplied to a decimation circuit 90 via a downsampling filter 89 (×1/2), where the data is downsampled by 1/2. The resulting data serves as upgrading data (difference data) of the upgrading type [3-1]. This upgrading data is input to an input terminal 2 of the selector 128.

When generating upgrading data of the upgrading type [4-2], first, audio data with format number 4 [44.1 kHz/20 bits] is supplied to an oversampling filter 84 (×2) via an interpolation circuit 83, where the audio data is oversampled by 2. The audio data is thus converted into a signal having a sampling frequency equivalent to that of a signal with format number 2 [88.2 kHz/24 bits], and the signal is output to a subtractor 88.

Audio data with format number 2 [88.2 kHz/24 bits] is temporarily stored in a buffer 86, and is then input to the subtractor 88. The subtractor 88 performs a subtraction to obtain difference of the data with format number 2 relative to the data with format number 4.

The data output from the subtractor 88 is supplied to a decimation circuit 92 via a downsampling filter 91 (×1/2), where the data is downsampled by 1/2, whereby upgrading data (difference data) of the upgrading type [4-2] is obtained. This upgrading data is input to an input terminal 3 of the selector 128.

When generating upgrading data of the upgrading type [5-2], first, audio data with format number 5 [44.1 kHz/16 bits] is supplied to an oversampling filter 94 (×2) via an interpolation circuit 93, where the audio data is oversampled by 2. The audio data is thus converted into a signal having a sampling frequency equivalent to that of a signal with format number 2 [88.2 kHz/24 bits], and the signal is input to a subtractor 96.

Audio data with format number 2 [88.2 kHz/24 bits] is temporarily stored in a buffer 95, and is then input to the subtractor 96.

A signal obtained by subtraction by the subtractor 96 is supplied to a decimation circuit 98 via a downsampling filter 97 (×1/2), where the signal is downsampled by 1/2. Thus, upgrading data (difference data) of the upgrading type [5-2] is obtained, which is input to an input terminal 4 of the selector 128.

Upgrading data of the upgrading type [5-4] is generated in the following manner.

Audio data with format number 5 [44.1 kHz/16 bits] and audio data with format number 4 [44.1 kHz/20 bits] have the same sampling frequency. Thus, in this case, a subtractor 99 subtracts the data with format number 5 from the data with format number 4. Data output from the subtractor 99 serves as upgrading data (difference data) of the upgrading type [5-4], which is input to an input terminal 5 of the selector 128.

Upgrading data of the upgrading type [6-2] is generated in the following manner.

Audio data with format number 6 [ATRAC] is audio data that is compressed based on ATRAC. Thus, the audio data with format number 6 [ATRAC] is input to a decoder 100, where the audio data is decoded, i.e., expanded. In this case, the signal obtained by decoding by the decoder 100 is audio data having a sampling frequency of 44.1 kHz.

The signal obtained by decoding by the decoder 100 is supplied to an oversampling filter 102 (×2) via an interpolation circuit 101, where the signal is oversampled by 2. The signal is thus converted into a signal having a sampling frequency equivalent to that of a signal with format number 2 [88.2 kHz/24 bits], and the signal is input to a subtractor 104.

Audio data with format number 2 [88.2 kHz/24 bits] is temporarily stored in a buffer 103, and is then input to the subtractor 104.

The signal obtained by subtraction by the subtractor 104 is supplied to a decimation circuit 106 via a downsampling filter 105 (×1/2), where the signal is downsampled by 1/2. Thus, upgrading data (difference data) of the upgrading type [6-2] is generated, which is input to an input terminal 6 of the selector 128.

When generating upgrading data of the upgrading type [6-4], data with format number 6 [ATRAC] is decoded by the decoder 100, and the signal obtained by decoding is input to a subtractor 108. Data with format number 4 [44.1 kHz/20 bits] is temporarily stored in a buffer 107, and is then input to the subtractor 108.

Data obtained by subtraction by the subtractor 108 is input to an input terminal 7 of the selector 108 as upgrading data (difference data) of the upgrading type [6-4].

When generating upgrading data of the upgrading type [6-5], a signal obtained by decoding data with format number 6 [ATRAC] by the decoder 100 is input to a subtractor 110. Data with format number 5 [44.1 kHz/16 bits] is temporarily stored in a buffer 109, and is then input to the subtractor 110.

Data obtained by subtraction by the subtractor 110 is input to an input terminal 8 of the selector 128 as upgrading data (difference data) of the upgrading type [6-5].

Upgrading data of the upgrading type [7-2] is generated in the following manner.

In this case, first, audio data with format number 7 [22.05 kHz/8 bits] is input to a signal processing line including an interpolation circuit 111, an oversampling filter 112 (×2), an interpolation circuit 113, and an oversampling filter 114 (×2). Thus, a signal output from the oversampling filter 114 has a sampling frequency equivalent to that of a signal with format number 2 [88.2 kHz/24 bits]. The signal output from the oversampling filter 114 is input to a subtractor 116.

Audio data with format number 2 [88.2 kHz/24 bits] is temporarily stored in a buffer 115, and is then input to the subtractor 116.

Data obtained by subtraction by the subtractor 116 is input to an input terminal 9 of the selector 128 as upgrading data (difference data) of the upgrading type [7-2].

When generating upgrading data of the upgrading type [7-4], first, audio data with format number 7 [22.05 kHz/8 bits] is converted by a signal processing line including the interpolation circuit 111 and the oversampling filter 112 (×2) into a signal having a sampling frequency equivalent to that of a signal with format number 4 [44.1 kHz/20 bits], which is input to a subtractor 118.

Audio data with format number 4 [44.1 kHz/20 bits] is temporarily stored in a buffer 117, and is then input to the subtractor 118.

A signal obtained by subtraction by the subtractor 118 is input to a decimation circuit 120 via a downsampling filter 119 (×1/2), where the signal is downsampled by 1/2. Data output from the decimation circuit 120 is input to an input terminal 10 of the selector 128 as upgrading data (difference data) of the upgrading type [7-4].

When generating upgrading data of the upgrading type [7-5], first, audio data with format number 7 [22.05 kHz/8 bits] is converted by the signal processing line including the interpolation circuit 111 and the oversampling filter 112 (×2) into a signal having a sampling frequency equivalent to that of a signal with format number 5 [44.1 kHz/16 bits], which is input to a subtractor 122.

Audio data with format number 5 [44.1 kHz/16 bits] is temporarily stored in a buffer 121, and is then input to the subtractor 122.

A signal obtained by subtraction by the subtractor 122 is supplied to a decimation circuit 124 via a downsampling filter 123 (×1/2), where the signal is downsampled by 1/2. Data output from the decimation circuit 124 is input to an input terminal 11 of the selector 128 as upgrading data (difference data) of the upgrading type [7-5].

When generating upgrading data of the upgrading type [7-6], first, audio data with format number 7 [22.05 kHz/8 bits] is converted by the signal processing line including the interpolation circuit 111 and the oversampling filter 112 (×2) into a signal having a sampling frequency of 44.1 kHz, which is equivalent to a sampling frequency of audio data that has been decoded by a decoder 125. In this case, data output from the oversampling filter 112 is temporarily stored in a buffer 129, and is then input to a subtractor 126.

In this case, audio data with format number 6 [ATRAC] is decoded by the decoder 125. The decoded audio data is input to the subtractor 126.

Difference data obtained by the subtractor 126 is uncompressed audio-data. Since upgrading data of the upgrading type [7-6] is used for upgrading to ATRAC data, the upgrading data must have a format based on ATRAC.

In this case, data output from the subtractor 126 is converted by an encoder 127 into a format of compressed audio data, for example, based on ATRAC. The data output from the encoder 127 is input to an input terminal 12 of the selector 128 as upgrading data (difference data) of the upgrading type [7-6].

The selector 128 receives input of upgrading data via the input terminals 0 to 12, as described above.

The selector 128 selectively outputs upgrading data from among the upgrading data input via the input terminals 0 to 12, according to a select signal generated based on upgrading-type information indicating an upgrading type.

The upgrading data output from the selector 128 is supplied to the encrypting unit 15 together with a header attached thereto under the control of the controller 11, and the upgrading data is encrypted in the encrypting unit 15. The encrypted upgrading data is sent from the interface 16 via the network 3 to the particular personal terminal 2 that has issued the relevant request for content.

The circuit configurations of the base-data generating unit 13 and the upgrading-data generating unit 14 are not limited to those shown in FIGS. 14 and 15. For example, since circuits having the same functions are often used for generating various base data and upgrading data, such circuits may be integrated so as to be commonly used for generating base data and updating data. With this arrangement, the circuit scale of the base-data generating unit 13 and the upgrading-data generating unit 14 is reduced, which is advantageous for reducing size and cost.

Furthermore, signal processing by the base-data generating unit 13 and the upgrading-data generating unit 14 may be executed by the controller 11 based on software.

4. Processes Executed for Content Distribution

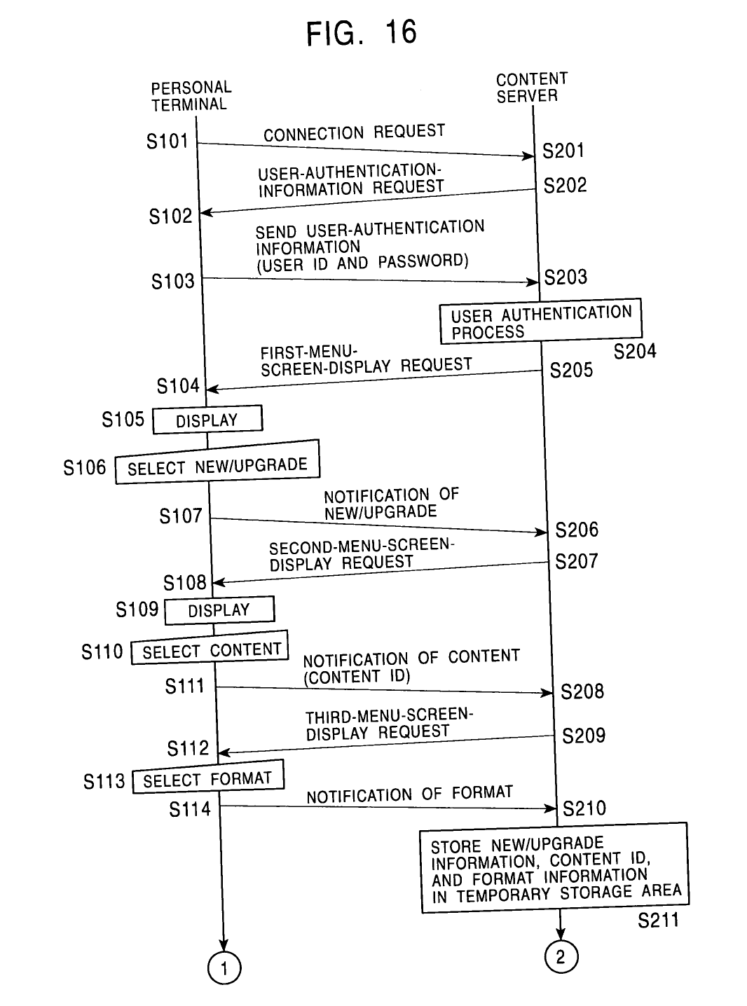

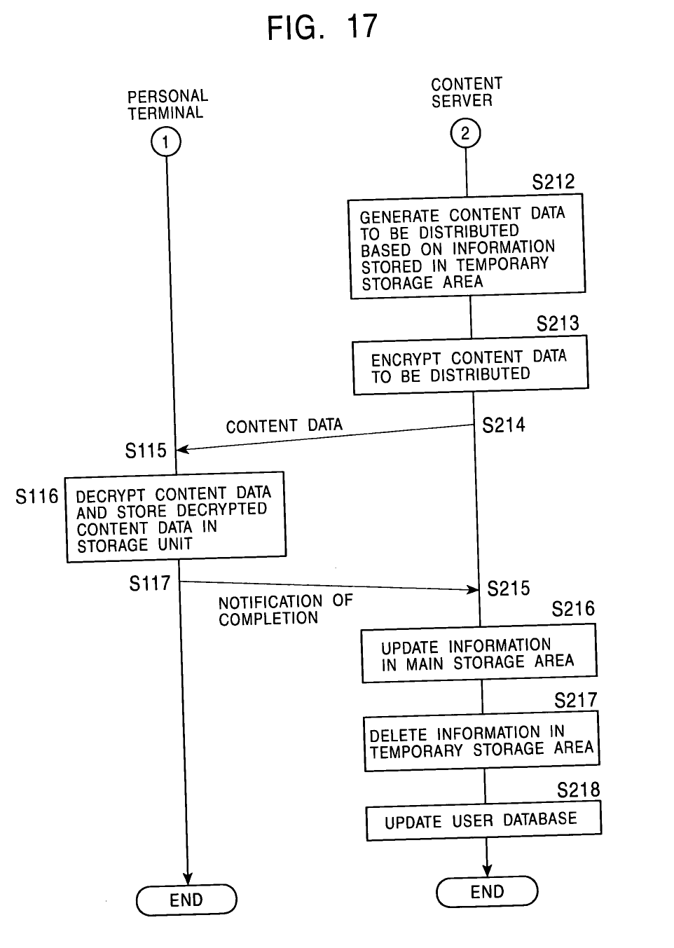

Next, processes executed by the content server 1 and the personal terminal 2 for distribution of content data in this embodiment will be described with reference to process transition charts (arrow charts) shown in FIGS. 16 and 17. The processes shown in FIGS. 16 and 17 are executed by a CPU of the controller 11 according to programs stored in the execution-program section 12D of the storage unit 12 at the content server 1, and by the CPU 21 according to programs stored in the storage unit 25 or the ROM 22 at the personal terminal 2.

First, let it be supposed that the user of the personal terminal 2 has performed a login operation for starting downloading of content data. Accordingly, in step S101, the personal terminal 2 sends a connection request to the content server 1.

Upon receiving the connection request in step S201, the content server 1 in step S202, sends a user-authentication-information request for requesting transmission of user authentication information, to the personal terminal 2 that has issued the connection request.

The personal terminal 2 receives the user-authentication-information request in step S102. In response to the user-authentication-information request, the personal terminal 2 sends user authentication information. The user authentication information that is sent herein includes a user ID and a password.

In the content distribution system of this embodiment, the user of the personal terminal 2 is registered as a user in advance in the content server 1 (distributor). The user ID is identification information that is uniquely assigned to each user by the content server 1 at the time of user registration. The user stores the user ID, for example, in the storage unit 25 of the personal terminal 2. The password is arbitrarily chosen and registered in the content server 1 by the user at the time of user registration. The content server 1 stores the user ID and the password registered at the time of user registration, as part of user information in the user database 12B-2 shown in FIG. 12.

When sending user authentication information in step S102, the personal terminal 2 reads the user ID stored in the storage unit 25, and the user enters a password by operating the input device 30.

The content server 1, upon receiving the user authentication information in step S203, executes user authentication in step S204.

In step S204, first, a user ID that coincides with the user ID included in the user authentication information received in the current session is searched for from the user database 12B-2 in the storage unit 12. Then, it is determined whether the password associated with the user ID found by the search matches the password included in the user authentication information received in the current session.

If it is determined that these passwords match, user authentication succeeds, and the content server 1 executes step S205 and subsequent steps. On the other hand, if a user ID that matches the user ID included in the user authentication information received in step S203 is not registered and is therefore not found in the user database 12B-2, or if a matching user ID is found but the associated password does not match the password included in the user authentication information received in step S203, user authentication fails. In this case, the content server 1 does not execute step S205 and subsequent steps for distribution of content data. Although not shown, the personal terminal 2 is notified of the failure of user authentication by the content server 1.

If user authentication succeeds in step S204, the content server 1 proceeds to step S205, sending request information for requesting display of a first menu screen for downloading content data, to the personal terminal 2.

The personal terminal 2, upon receiving the request information for displaying the first menu screen in step S104, proceeds to step S105, exercising control to display the first menu screen on the display 29. The first menu screen is a GUI screen that allows selection as to whether the current downloading of content data is new downloading of new content or upgrade downloading for upgrading base data of content that has already been obtained.

Then, in step S106, the user selects either new downloading or upgrade downloading on the first menu screen using the input device 30.

In accordance with the selecting operation by the user in step S106, the personal terminal 2, in step S107, sends notification information for notification of either new downloading or upgrade downloading, as the case may be, to the content server 1.

The content server 1 receives the notification information of either new downloading or upgrade downloading in step S206. Although not shown, the notification information of either new downloading or upgrade downloading, received in step S206, is temporarily stored in the RAM of the controller 11.

Then, in step S207, the content server 1 sends request information for requesting display of a second menu screen to the personal terminal 2.

The personal terminal 2, upon receiving the request for displaying the second menu screen in step S108, proceeds to step S109, exercising control to display the second menu screen on the display 29.

The second menu screen is a GUI screen that presents a menu for selecting content to be downloaded. In step S110, the user selects content on the second menu screen. For example, in accordance with the selecting operation by the user, notification information for notification of content selected is sent to the content server 1 in step S111. The notification of content is executed by sending an associated content ID to the content server 1. The content ID is an identifier that is uniquely assigned to each piece of content by the distributor, i.e., by the content server 1. The selection of content on the second menu screen at the personal terminal 2 is actually selection of a content ID.

The content server 1, upon receiving the content-notification information from the personal terminal 2 in step S208, stores the content ID included in the content-notification information, for example, in the RAM of the controller 11. Then, in step S209, the content server 1 sends request information for requesting display of a third menu screen to the personal terminal 2.

The personal terminal 2, upon receiving the request information for displaying the third menu screen in step S112, proceeds to step S113, exercising control to display the third menu screen on the display 29.

The third menu screen is a GUI screen for allowing selection of a format of content to be downloaded. In step S113, the user selects a format using the input device 30.

With regard to the selection of format, if new downloading is selected in step S106, a format of base data is selected. On the other hand, if upgrade downloading is selected in step S106, an upgrading format that is obtained by combining upgrading data and base data (see FIG. 8) is selected.

When a format has been selected and determined in step S113, the personal terminal 2 proceeds to S114, sending notification information of the format determined to the content server 1.

In step S210, the content server 1 receives the format-notification information transmitted from the personal terminal 2 via the network 3, and stores the format-notification information in, for example, the RAM of the controller 11.

By the processing described above, as information relating to the current downloading of content data, the RAM of the controller 11 of the content server 1 stores information indicating distinction between new downloading and upgrade downloading (new/upgrade information), a content ID representing content to be downloaded, and format information indicating a format of the content to be downloaded.

In step S211, the content server 1 writes the new/upgrade information, the content ID, and the format information in the temporary storage area Ar1 of the storage unit 25 as temporary usage-history information, for example, in association with the user ID.

Then, the content server 1 proceeds to step S212 shown in FIG. 17. In step S212, the content server 1 generates content data to be distributed, based on the temporary usage-history information stored in the temporary storage area Ar1 in step S211.

If the new/upgrading information stored in the temporary storage area Ar1 specifies new downloading, the content data to be distributed, generated in step S212, is base data.

Thus, first, the controller 11 searches the storage unit 25 for original content data having the content ID stored in the temporary storage area Ar1. That is, the controller 11, using the content database 12A-2 in the content-related-information section 12A, searches the content-data set 12A-1 for original content data represented by the content ID stored in the temporary storage area Ar1.

The controller 11 inputs the original content data found by the search to the base-data generating unit 13, and outputs a select signal corresponding to a format number of the format information stored in the temporary storage area Ar1.

Thus, the base-data generating unit 13 generates base data in a format having the format number corresponding to the format information stored in the temporary storage area Ar1. The base data generated as described above is used as content data for the current distribution.

On the other hand, if the new/upgrading information stored in the temporary storage area Ar1 specifies upgrade downloading, data to be generated in step S212 is upgrading data.

In that case, first, the controller 11 accesses the user database 12B-2 based on the user ID of the user that has issued the current upgrading request. The controller 11 recognizes a usage-history pointer associated with the user ID from the user database 12B-2 (see FIG. 12), and refers to information indicated by the history-information pointer among usage-history information in the main storage area Ar2 (see FIG. 11).

As described with reference to FIG. 12, the usage-history-information section 12B-1 stores formats of base data and upgrading data that have been downloaded by the user, in association with content IDs, as usage-history information of individual users.

The controller 11, from among the usage-history information stored in the usage-history-information section 12B-1, recognizes usage-history information regarding content data that is associated with a content ID that matches the content ID written in the temporary storage area Ar1. When upgrade downloading is specified, information regarding the content data represented by the content ID written in the temporary storage area Ar1 indicates a format of base data (base format) that has already been downloaded. That is, before content data is sent based on the current downloading request, the controller 11 recognizes a format of base data that has already been distributed.

As described above, the controller 11 has obtained information of a format of base data (base format) that has already been distributed, and information of an upgrading format relevant to the current request (format information written in the temporary storage area Ar1).

The controller 11 searches for original content data having a content ID that matches the content ID written in the temporary storage area Ar1, and inputs the original content data to the base-data generating unit 13. Based on the input original content data, the base-data generating unit 13 generates two pieces of audio data, namely, audio data with a format number of the base format and audio data with a format number of the upgrading format. These two pieces of content data relate to the same content but have mutually different formats.

The two pieces of audio data that have been generated are input to the upgrading-data generating unit 14.

The upgrading-data generating unit 14, under the control of the controller 11, generates difference data between the two pieces of audio data input thereto as described above. The difference data represents the difference between the format of the base data that has already been downloaded and the upgrading format specified in the current downloading request. That is, the difference data serves as upgrading data. The upgrading data generated as described above serves as content data to be distributed.

As described above, in step S212, according to the information written in the temporary storage area Ar1, base data or upgrading data is generated as content data to be distributed, based on content represented by the specified content ID and the specified format.

At the content server 1, in step S213, the encrypting unit 15 encrypts the content data to be distributed, generated as described above. Then, in step S214, the content server 1 sends the encrypted content data to the personal terminal 2 that has issued the relevant request.

The personal terminal 2, upon receiving the distributed content data in step S115, decrypts the distributed content data in step S116. More specifically, the distributed content data received is supplied to the decrypting unit 24, and the decrypting unit 24 decrypts the distributed content data. The decrypted content data is supplied to the storage unit 25, where it is stored as a piece of content data.

At the personal terminal 2, when the content data has been decrypted and the decrypted content data has been stored in the storage unit 25 in step S116, the current downloading is successfully completed.

If step S116 completes normally, the personal terminal 2 proceeds to step S117, sending data of a notification of completion to the content server 1.

The content server 1, in step S215, receives the data of the notification of completion from the personal terminal 2. By the receipt of the data of the notification of completion, the content server 1 is allowed to recognize that the content data sent in the current session has been successfully downloaded by the personal terminal 2. Accordingly, the content server 1, for subsequent downloading and charging, must update the usage-history information and the user database so as to reflect the downloading operation of the current session.

Thus, first, in step S216, the content server 1, based on the information stored in the temporary storage area Ar1 in step S211, updates usage-history information in the usage-history-information section 12B-1, associated with the user ID of the user that has used the content distribution service in the current session, among the usage-history information stored in the main storage area Ar2.

At this time, the content ID of the content data distributed in the current session is recognized by referring to the information stored in the temporary storage area Ar1. Thus, if distributed content data is base data, a base format thereof is recognized, and if distributed content data is upgrading data, an upgrading format thereof is recognized.

If the distributed content data is base data, the controller 11 newly records the content ID recognized in the usage-history-information section 12B-1, and records the format of base data (base format) distributed in the current session, in association with the content ID recognized.

If the distributed content data is upgrading data, since a content ID that matches the content ID recognized is already stored in the usage-history-information section 12B-1, data regarding a format to which upgrading is allowed by the upgrading data distributed in the current session (upgrading format) is recorded.

When the above process is complete, the information written in the temporary storage area Ar1 is no longer needed. Thus, in step S217, the information written in the temporary storage area Ar1 is deleted.

Then, in step S218, the information stored in the user database 12B-2 is updated in accordance with content distribution in the current session.

More specifically, the user database 12B-2 stores history of used genres, and monthly charge, as information associated with each user ID.

The controller 11, for example, determines a genre of content data distributed in the current session, by referring to the content database 12A-2 stored in the storage unit 25. The controller 11 then updates information regarding the history of used genres based on the genre determined.

The controller 11 also calculates a price for the content data distributed in the current session, by referring to the charge-information section 12C-1 in the storage unit 25. The controller 11 then updates information of monthly charge based on the price calculated. Although not shown, the content server 1 executes a charging process at an appropriate occasion and timing, for example, based on the updated information regarding monthly charge.

5. Signal Processing of Content Data at the Personal Terminal

By execution of the processes shown in FIGS. 16 and 17, the personal terminal 2 is allowed to download base data of content and store the base data in the storage unit 25, and is also allowed to download upgrading data of the same content of which base data has already been downloaded, and store the upgrading data in the storage unit 25.

With regard to the content data downloaded and stored as described above, the personal terminal 2 is allowed to play back the base data independently to output a corresponding sound. Also, the personal terminal 2 is allowed to play back and output a sound in a format of a quality higher than the quality of the format of base data by combining the base data and the upgrading data.

Signal processing for combining the base data and the upgrading data for generating audio data in an upgraded format is executed by the content-data combining unit 26.

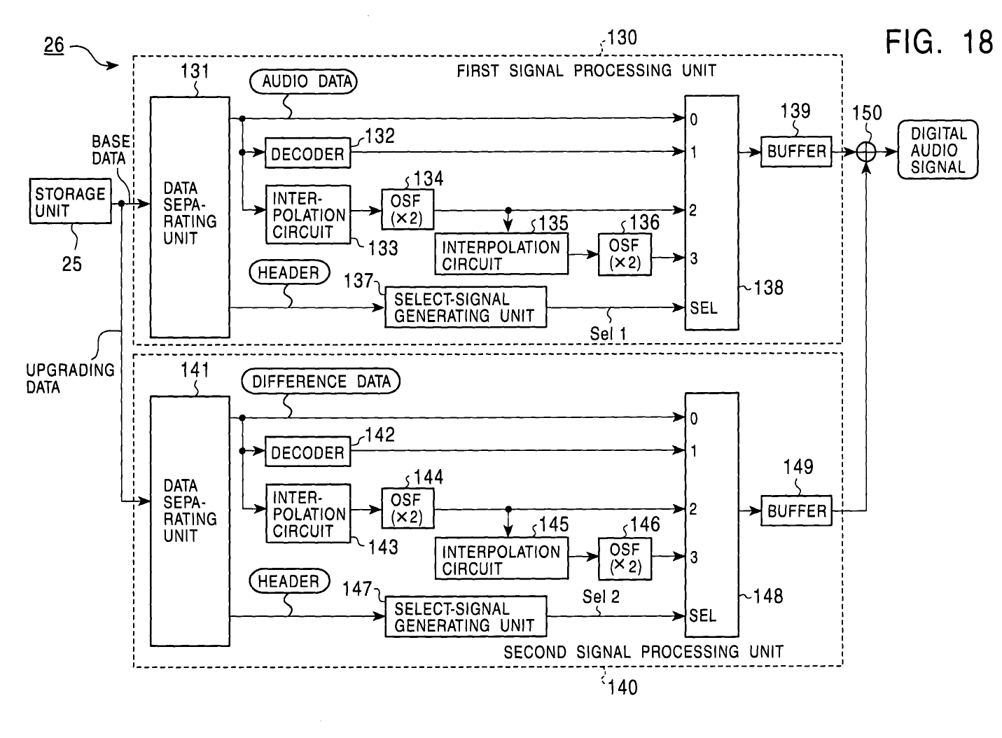

Thus, an example circuit configuration of the content-data combining unit 26 will next be described with reference to FIG. 18.

The content-data combining unit 26 shown in FIG. 18 generally includes a first signal processing unit 130 and a second signal processing unit 140. In this example, the first signal processing unit 130 is in charge of processing base data supplied from the storage unit 25, and the second signal processing unit 140 is in charge of processing upgrading data supplied from the storage unit 25.

Base data that is supplied to the first signal processing unit 130 from the storage unit 25 is first input to a data separating unit 131. The base data stored in the storage unit 25 includes a header and audio data, as shown in parts (a) and (b) of FIG. 5. The data separating unit 131 separates the input base data into a header and audio data. The separated audio data is branched and input to a terminal 0 of a selector 138, a decoder 132, and an interpolation circuit 133.

The separated header information is input to a select-signal generating circuit 137.

The decoder 132, if the input audio data is compressed based on ATRAC, decodes (expands) the audio data based on ATRAC into audio data having a sampling frequency of, for example, 44.1 kHz, and supplies the decoded audio data to a terminal 1 of the selector 138.

The audio data input to the interpolation circuit 133 is interpolated therein, and the result is oversampled by 2 by an oversampling filter 134 (×2) at a downstream thereof.

A signal output from the oversampling filter 134 is branched and input to a terminal 2 of the selector 138 and an interpolation circuit 135.

The signal supplied from the oversampling filter 134 goes through the interpolation circuit 135 and an oversampling filter 136 (×2), whereby the signal is further oversampled by two. A signal output from the oversampling filter 136 is supplied to a terminal 3 of the selector 138.

The select-signal generating unit 137 extracts content-grade identification information from the separated header, and analyzes the content-grade identification information, thereby recognizing a format (format number) of the base data input to the first signal processing unit 130. The select-signal generating circuit 137 outputs a select signal Sel1 in accordance with the format recognized to a terminal SEL of the selector 138.

The selector 138 selects one of the terminals 0 to 3 according to the select signal Sel1 input to the terminal SEL, and outputs a signal input to the selected terminal to a buffer 139. The buffer 139 temporarily stores the signal supplied from the selector 138, and then outputs the signal to a combining unit 150.

The buffer 139 is provided for adjusting time so that a signal output from the first signal processing unit 130 is synchronized with a signal output from the second signal processing unit 140.

The second signal processing unit 140 includes a data separating unit 141, a decoder 142, an interpolation circuit 143, an oversampling filter 144 (×2), an interpolation circuit 145, an oversampling filter 146 (×2), a select-signal generating circuit 147, a selector 148, and a buffer 149, these components being connected to each other, similarly to the first signal processing unit 130.

Upgrading data includes a header and difference data, as shown in parts (a) and (b) of FIG. 6. The data separating unit 141 of the second signal processing unit 140 separates upgrading data into difference data and a header. The second signal processing unit 140 processes the separated difference data similarly to the first signal processing unit 130, and resulting signals are input to terminals 0 to 3 of the selector 148.

The select-signal generating circuit 147 of the second signal processing unit 140 extracts content-grade identification information included in the separated header, and analyzes the content-grade identification information, thereby recognizing an upgrading type of the upgrading data. The select-signal generating unit 147 then outputs a select signal Sel2 in accordance with the upgrading type recognized to a terminal SEL of the selector 148.

The buffer 149 of the second signal processing unit 140, similarly to the buffer 139 of the first signal processing unit 130, is provided to absorb time difference so that a signal output from the second signal processing unit 140 will be synchronized with a signal output from the first signal processing unit 130.

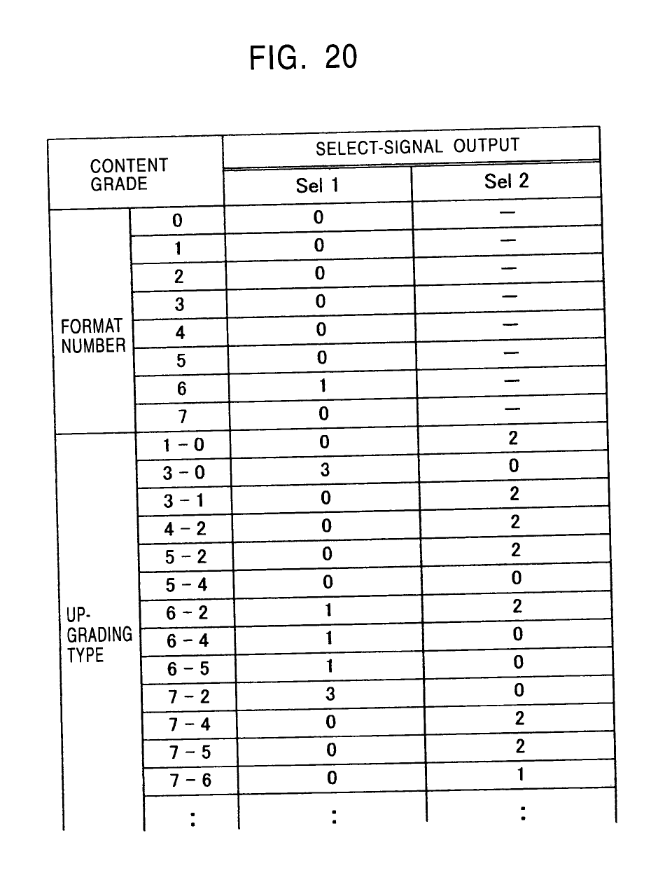

The select-signal generating circuits 137 and 147 generate select signals Sel1 and Sel2 based on the content-grade identification information (the format number of the base data and the upgrading type of the upgrading data) recognized as described above, as shown in FIG. 20.

In FIG. 20, in the vertical direction, regarding content grade, format numbers 0 to 7 are shown in an upper section. In association with the format numbers 0 to 7, terminal numbers that are to be selected by the selector 138 according to the select signal Sel1 are shown. Format numbers 0 to 7 allow independent playback of base data. If content data to be played back is base data only, only the first signal processing unit 130 is activated.

The select signal Sel is such that the terminal 1 is selected if the format number is 6, that is, if the base data is audio data compressed based on ATRAC, while the terminal 0 is selected in the case of other format numbers.

By generating the select signal Sel1 as described above, when only base data is played back, a suitable signal processing line is selected in the first signal processing unit 130 so that a suitable playback signal will be supplied to the audio-signal processing unit 27 via the combining unit 150.

In FIG. 20, below the format numbers 0 to 7, upgrading types [1-0] to [7-6] are shown as content grades. In association with the upgrading types, terminal numbers of the selectors 138 and 148 that are to be selected according to the select signals Sel1 and Sel2 are shown.

For example, in the case of an upgrading type [1-0], the first signal processing unit 130 receives input of audio data with format number 1 as base data, and the second signal processing unit 140 receives input of upgrading data corresponding to the upgrading type [1-0].

Referring to FIG. 20, when upgrading of the upgrading type [1-0] is performed for playback, the select-signal generating circuit 137 of the first signal processing unit 130 generates a select signal Sel1 for selecting the terminal 0. The select-signal generating circuit 147 of the second signal processing unit 140 generates a select signal Sel2 for selecting the terminal 2. Signals that are selected by the selectors 138 and 148 according to the select signals Sel1 and Sel2 are output to the combining unit 150 via the buffers 139 and 149. The combining unit 150 combines the signals to output a digital audio signal that has been upgraded from base data with format number 1 to the format with format number 0.

That is, the select-signal generating circuits 137 and 147 switch the selectors 138 and 148 in accordance with formats of input data, as shown in FIG. 20. Accordingly, the content-data combining unit 26 outputs a suitable combined playback signal (digital audio signal). Also, when only base data is to be played back, a playback signal (digital audio signal) in a suitable format is output to the audio-signal processing unit 27.

With the configuration of the content-data combining unit 26 shown in FIG. 18, base data is upgraded with a single piece of upgrading data to output a digital audio signal.

However, the configuration of the content-combining unit 26 shown in FIG. 18 is only an illustration of a scheme for combining content according to the present invention.

For example, if base data has been upgraded with a single piece of upgrading data of a certain upgrading type to output a digital audio signal, the upgraded digital audio signal may be further upgraded with further upgrading data for upgrading to a format of an even higher grade, whereby a digital audio signal of an even higher quality is obtained. That is, it is technically feasible to upgrade a single piece of base data with a plurality of pieces of upgrading data (difference data), and the content-data combining unit 26 may be configured so as to support this technical feature.

In order to allow upgrading of a single piece of base data with a plurality of pieces of upgrading data (difference data), the configuration of the content-data combining unit 26 shown in FIG. 18 is modified, for example, as follows.

In addition to the first signal processing unit 130 and the second signal processing unit 140 shown in FIG. 18, a required number of signal processing units is provided. The signal processing units additionally provided are configured, for example, similarly to the first signal processing unit 130 and the second signal processing unit 140.

For example, in order to allow upgrading of a single piece of base data with three pieces of upgrading data, in addition to the signal processing unit 130 for signal processing of base data and the second signal processing unit 140 for processing of one piece of upgrading data, two signal processing units are further provided for processing of the other two pieces of upgrading data.

Select-signal generating circuits of the signal processing units are configured such that select signals that cause suitable selector terminals to be selected are generated in accordance with content grades (formats and upgrading types) of base data and upgrading data.

Signals that have been suitably processed by the signal processing units are combined by a combining unit to output a single digital audio signal.

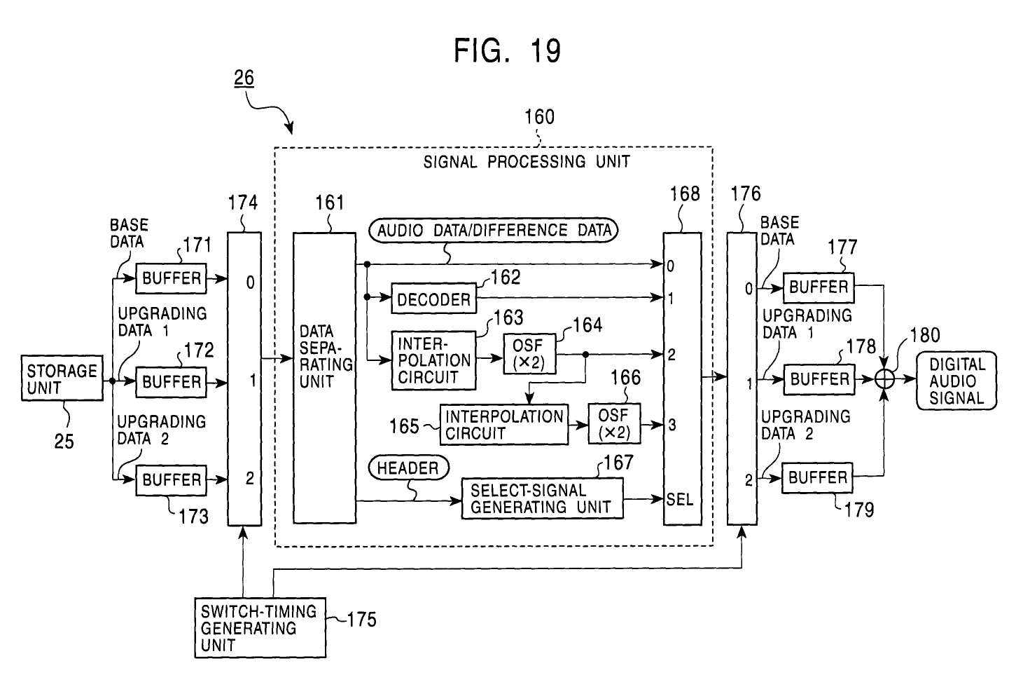

According to the present invention, the content-data combining unit 26 may be configured such that a common signal processing unit is provided for base data and a required number of pieces of upgrading data to be processed, the signal processing unit processing the base data and the required number of pieces of upgrading data by time division. FIG. 19 shows an example of such configuration.

In the example shown in FIG. 19, the content-data combining unit 26 allows upgrading of a single piece of base data with at most two pieces of upgrading data 1 and 2. Obviously, the content-data combining unit 26 is allowed to upgrade base data with the single piece of upgrading data 1. However, the following description deals with a case where base data is upgraded with the two pieces of upgrading data 1 and 2.

In the example shown in FIG. 19, a single piece of base data and two pieces of upgrading data 1 and 2 associated with the same content are read from the storage unit 25.

Of the data read from the storage unit 25, the base data is supplied to a buffer 171. The upgrading data 1 is supplied to a buffer 172. The upgrading data 2 is supplied to a buffer 173.

A selector 174 switches data to be input to a signal processing unit 160, by time division, from among the base data and the upgrading data 1 and 2, respectively stored in the buffers 171, 172, and 173. That is, the selector 174 selects one of terminals 0, 1, and 2 at appropriate timing, according to a select signal supplied from a switch-timing generating circuit 175. Thus, the base data and the upgrading data 1 and 2 are input sequentially, i.e., by time division, from the selector 174 to the signal processing unit 160. In this case, for example, the base data and the upgrading data 1 and 2 are input sequentially by units of a predetermined data size.

As shown in FIG. 19, the signal processing unit 160 includes a data separating unit 161, a decoder 162, an interpolation circuit 163, an oversampling filter 164, an interpolation circuit 165, an oversampling filter 166, a select-signal generating circuit 167, and a selector 168, connected as shown. That is, the signal processing unit 160 is configured similarly to the first signal processing unit 130 and the second signal processing unit 140.

The signal processing unit 160 processes the base data and the upgrading data 1 and 2 input thereto by time division, similarly to the signal processing unit 130 described earlier with reference to FIG. 18, and outputs data via the selector 168.

The data output from the selector 168 is then input to a selector 176. The selector 176, according to the select signal input from the switch-timing generating circuit 175, outputs data input from the selector 168 via one of terminals 0, 1, and 2. If the data output from the signal processing unit 160 is base data of audio data, the selector 176 supplies the base data to a buffer 177 via the terminal 0. If the data output from the signal processing unit 160 is difference data of the upgrading data 1, the selector 176 supplies the difference data to a buffer 178 via the terminal 1. If the data output from the signal processing unit 160 is difference data of the upgrading data 2, the selector 176 outputs the difference data to a buffer 179 via the terminal 2.

Each of the buffers 177, 178, and 179 temporarily store data supplied thereto from the selector 176. The base data and the upgrading data 1 and 2 are read respectively from the buffers 177, 178, and 179 so that the playback time axes thereof will be synchronized with each other, and are output to a combining unit 180.

The combining unit 180 combines the base data and the upgrading data 1 and 2 read from the buffers 177, 178, and 179. Thus, the base data is upgraded with the upgrading data 1 and 2, whereby an upgraded digital audio signal is obtained.

According to the arrangement described above, signal processing units to be provided respectively for base data and a required number of pieces of upgrading data can be integrated into a single signal processing unit. Thus, the circuit scale of the content-data combining unit 26 can be reduced, serving to reduce cost and to reduce the physical size of the circuit.

Signal processing by the content-data combining unit 26 shown in FIGS. 18 and 19 may alternatively be implemented in software. In that case, the CPU 21 processes base data and upgrading data using the RAM 23 as a work area, thereby generating an upgraded digital audio signal.

According to the present invention, programs for implementing the processes shown in FIGS. 16 and 17 are stored in advance as execution programs in, for example, the storage unit 12 of the content server 1, as described earlier.

As for the personal terminal 2, programs for implementing the processes shown in FIGS. 16 and 17 are stored in the ROM 22 or the storage unit 25.

The programs for implementing the processes shown in FIGS. 16 and 17 may be stored (recorded) temporarily or permanently on a removable recording medium such as a flexible disc, a compact disc read-only memory (CD-ROM), a magneto-optical disc (MO), a digital versatile disc (DVD), a magnetic disc, or a semiconductor memory. The removable recording medium may be provided in the form of what is called package media having the programs stored thereon. By configuring the content server 1 and the personal terminal 2 so as to allow reading data from the package media, the content server 1 and the personal terminal 2 are allowed to read execution programs from the package media and to install the execution programs in, for example, the storage units 12 and 25. Instead of installing the programs from removable recording media as described above, alternatively, the execution programs may be downloaded from a server or the like that stores the programs via a network such as a local area network (LAN) or the Internet, installing the downloaded execution programs.

The scope of the present invention is not limited to the embodiments described hereinabove. For example, various information that is to be stored in the storage unit 12 for content distribution by the content server 1, and the structures thereof, described with reference to FIGS. 7 to 13, are only examples, and may be modified as needed.

According to the present invention, it suffices for the content server 1 to store only original content data as material of content to be distributed. This serves to save the storage capacity of the storage unit 12. However, it is possible to store base data and upgrading data, not all, but base data and upgrading data of formats or upgrading types that have frequently been distributed, in the content-related-information section 12A of the storage unit 12. In that case, content that is frequently distributed can be read from the storage unit 12 and sent without generating base data or upgrading data, reducing the processing load of the content server 1.

Although content data to be distributed has been described as audio data in the embodiments described above, the scope of the present invention is not limited to applications for audio data. For example, video data may be used as content to be distributed according to the present invention.

What is claimed is:

1. A data distribution method comprising the steps of:
classifying information for downloading content, transmitted from a user;
selecting one of a plurality of pieces of content data having predetermined formats, based on the information for downloading content, and sending the selected content data to the user, when the information for downloading content is classified as indicating downloading of new content data; and
sending upgrading data to the user when the information for downloading content is classified as indicating downloading of upgrading data associated with content data owned by the user.

2. A data distribution method according to claim 1, wherein when the information for downloading content is classified as indicating downloading of upgrading data, the upgrading data is generated from the content data owned by the user and content data associated therewith among the plurality of pieces of content data, and the upgrading data generated is sent to the user.

3. A data distribution method according to claim 2, wherein the information for downloading content at least includes information for selecting a piece of content data from the plurality of pieces of content data, and information for specifying a format of content data to be downloaded, and difference data is generated, based on the information for specifying the format, from the content data owned by the user and content data associated therewith, the difference data being sent to the user as the upgrading data.

4. A data distribution method according to claim 3, wherein the difference data is generated based on the information for specifying the format and information regarding a format used when sending the content data owned by the user, the information regarding the format being stored as usage-history information.

5. A data distribution method according to claim 1, wherein the information for downloading content at least includes selection information indicating either downloading of new content data or downloading of upgrading data and information for specifying a format of content data to be downloaded, and whether new content data is to be downloaded or upgrading data is to be downloaded is determined based on the selection information.

6. A data distribution method according to claim 5, wherein when the information for downloading content is classified as indicating downloading of new content data, the selected content data is converted into a format based on the information for specifying the format before the selected content data is sent to the user.

7. A data distribution method according to claim 1, wherein the information for downloading content includes user-specific information, temporary history information is generated based on the information for downloading content on a basis of the user-specific information, and usage-history information is updated based on the temporary history information after processing of data received by the user is completed.

8. A data distribution method according to claim 1, wherein user authentication is executed, and processing based on the information for downloading content is started when the user authentication succeeds.

9. A data distribution method according to claim 1, wherein the selected content data or the upgrading data is encrypted before the selected content data or the upgrading data is sent to the user.

10. A server comprising:
a storage unit that stores a plurality of pieces of content data having predetermined formats;
a first generating unit for generating content data to be distributed, based on data supplied thereto;
a second generating unit for generating upgrading data using content data read from the storage unit;
a sending and receiving unit to which data output from the first generating unit or the second generating unit is supplied, for sending and receiving data to and from outside via a network; and
a controller to which information for downloading content received by the sending and receiving unit is supplied, for exercising control based on the information for downloading content;
wherein the controller classifies the information for downloading content, wherein the controller selects one of the plurality of pieces of content data having the predetermined formats, based on the information for downloading content, and supplies the selected content data to the first generating unit, when the information for downloading content is classified as indicating downloading of new content data, and wherein the controller causes the second generating unit to generate upgrading data when the information for downloading content is classified as indicating downloading of upgrading data associated with content data owned by the user.

11. A server according to claim 10, wherein the controller reads the content data owned by the user and content data associated therewith among the plurality of pieces of content data from the storage unit, and supplies these content data to the second generating unit.

12. A server according to claim 11, wherein the information for downloading content at least includes information for selecting a piece of content data from the plurality of pieces of content data, and information for specifying a format of content data to be downloaded, and the controller causes the second generating unit to generate difference data, based on the information for specifying the format, from the content data owned by the user and content data associated therewith, the difference data being supplied to the sending and receiving unit as the upgrading data.

13. A server according to claim 12, further comprising another storage unit that stores usage-history information, wherein the controller causes the second generating unit to generate difference data based on the information for specifying the format and information regarding a format used when sending the content data owned by the user, the information regarding the format being included in the usage-history information read from the another storage unit.

14. A server according to claim 10, wherein the information for downloading content at least includes selection information indicating either downloading of new content data or downloading of upgrading data and information for specifying a format of content data to be downloaded, and the controller determines whether new content data is to be downloaded or upgrading data is to be downloaded based on the selection information.

15. A server according to claim 14, wherein when the information for downloading content is classified as indicating downloading of new content data, the first generating unit converts the selected content data into a format based on the information for specifying the format.

16. A server according to claim 10, further comprising another storage unit that stores usage-history information, wherein the information for downloading content includes user-specific information, and wherein the controller generates temporary history information based on the information for downloading content on a basis of the user-specific information, and updates the usage-history information in the another storage unit based on the temporary history information.

17. A server according to claim 10, wherein the sending and receiving unit encrypts the data supplied thereto and outputs the encrypted data.

18. A terminal comprising:
a sending and receiving unit for sending and receiving data to and from a server via a network;
a storage unit for storing content data and upgrading data received from the sending and receiving unit;
a signal processing unit for decoding content data read from the storage unit, in accordance with encoding of the content data, and for generating content data having a quality higher than a quality of the content data read from the storage unit, based on the content data and upgrading data read from the storage unit; and
a controller for exercising control as to whether the signal processing unit decodes the content data read from the storage unit or generates the content data having the higher quality.

19. A terminal according to claim 18, wherein the signal processing unit comprises:
a generating unit for generating content data having a higher quality than a quality of the content data read from the storage unit, based on the content data and upgrading data read from the storage unit; and
a first decoder for decoding the content data read from the storage unit and supplied to the first decoder.

20. A terminal according to claim 19, wherein the generating unit comprises a second decoder for decoding the upgrading data supplied thereto.

21. A terminal according to claim 20, wherein the generating unit further comprises a combining unit for combining data output from the first decoder and data output from the second decoder.

22. A terminal according to claim 20, wherein the controller activates the first decoder when the content data read from the storage unit is to be played back, while activating the first decoder and the second decoder when the content data having the higher quality is to be generated.

23. A terminal according to claim 18, wherein the controller sequentially reads the content data and the upgrading data from the storage unit, and supplies the content data and the upgrading data to the signal processing unit.

24. A terminal according to claim 23, further comprising a plurality of buffer memories provided between the storage unit and the signal processing unit, wherein the controller controls switching of the plurality of buffer memories.

25. A terminal according to claim 18, further comprising an operating unit that is operated by a user, wherein the controller, based on an input via the operating unit, generates information for downloading content, the information for downloading content including information indicating whether new content data is to be downloaded or upgrading data for content data already stored in the storage unit is to be downloaded, and sends the information for downloading content via the sending and receiving unit.

26. A terminal according to claim 18, further comprising a decrypting unit for decrypting encrypted data supplied thereto from the sending and receiving unit.

27. A terminal according to claim 18, wherein the controller sends data indicating completion of processing via the sending and receiving unit when writing of data received by the sending and receiving unit to the storage unit is completed.
